(19) United States
(12) Patent Application Publication
(10) Pub. No.: US 2025/0077911 A1
(43) Pub. Date: Mar. 6, 2025

(54) CONTAINERIZED DATA CENTER APPARATUS FOR RAPID RESPONSE OR EMERGENCY DEPLOYMENT

(71) Applicant: Armada Systems Inc., Greebrae, CA (US)

(72) Inventors: Pradeep Nair, Greebrae, CA (US); Pragyana K Mishra, Seattle, WA (US)

(21) Appl. No.: 18/649,775

(22) Filed: Apr. 29, 2024

Related U.S. Application Data
(63) Continuation-in-part of application No. 18/461,470, filed on Sep. 5, 2023, now Pat. No. 12,014,219.

(51) Int. Cl. G06N 5/04; G06F 1/26

(52) U.S. Cl. CPC G06N 5/04; G06F 1/26

(57) ABSTRACT

A rapid response containerized edge data center apparatus can be deployed to an edge location associated with an emergency event, and can comprise a form factor based on a shipping container housing. One or more electrical generators and battery arrays can generate and provide electrical power to the apparatus. Server racks within the container housing can implement local inference for machine learning (ML) or artificial intelligence (AI) applications corresponding to emergency response applications or tools. The apparatus can include a local networking node to create local networks at the edge location, and a plurality of satellite transceivers for link-bonded communications and internet backhaul to one or more satellite internet constellations. A communications hub engine can be configured to provide communications relay between devices on the local networks, and to connect the devices on the local networks to remote endpoints reachable over the bonded satellite uplink and bonded satellite downlink.

### FIELD

The present disclosure pertains to edge computing, and more specifically pertains to systems and techniques for providing high-performance and low-latency edge computing during emergency and/or rapid response deployment scenarios.

### BACKGROUND

Edge computing is a distributed computing paradigm that can be used to decentralize data processing and other computational operations by bringing compute capability and data storage closer to the edge (e.g., the location where the compute and/or data storage is needed, often at the “edge” of a network such as the internet). Edge computing systems are often provided in the same location where input data is generated and/or in the same location where an output result of the computational operations is needed. The use of edge computing systems can reduce latency and bandwidth usage, as data is ingested and processed locally at the edge and rather than being transmitted to a more centralized location for processing.

In many existing cloud computing architectures, data generated at endpoints (e.g., mobile devices, Internet of Things (IoT) sensors, robots, industrial automation systems, security cameras, etc., among various other edge devices and sensors) is transmitted to centralized data centers for processing. The processed results are then transmitted from the centralized data centers to the endpoints requesting the processed results. The centralized processing approach may present challenges for growing use cases, such as for real-time applications and/or artificial intelligence (AI) and machine learning (ML) workloads. For instance, centralized processing models and conventional cloud computing architectures can face constraints in the areas of latency, availability, bandwidth usage, data privacy, network security, and the capacity to process large volumes of data in a timely manner.

In the context of edge computing, the “edge” refers to the edge of the network, close to the endpoint devices and the sources of data. In an edge computing architecture, computation and data storage are distributed across a network of edge nodes that are near the endpoint devices and sources of data. The edge nodes can be configured to perform various tasks relating to data processing, storage, analysis, etc. Based on using the edge nodes to process data locally, the amount of data that is transferred from the edge to the cloud (or other centralized data center) can be significantly reduced. Accordingly, the use of edge computing has become increasingly popular for implementing a diverse range of AI and ML applications, as well as for serving other use cases that demand real-time processing, minimal latency, high availability, and high reliability.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. The use of a same reference numbers in different drawings indicates similar or identical items or features. Understanding that these drawings depict only exemplary embodiments of the disclosure and are not therefore to be considered to be limiting of its scope, the principles herein are described and explained with additional specificity and detail through the use of the accompanying drawings in which:

FIG. 1 depicts an example design of a base station and a user equipment (UE) for transmission and processing of signals exchanged between the UE and the base station, in accordance with some examples;

FIG. 2A is a diagram illustrating an example configuration of a Non-Terrestrial Network (NTN) for providing data network connectivity to terrestrial (ground-based) devices, in accordance with some examples;

FIG. 2B is a diagram illustrating an example of a satellite internet constellation network that can be used to provide low latency satellite internet connectivity, in accordance with some examples;

FIG. 3A is a diagram illustrating an example perspective view of a containerized data center unit for edge computing deployments, in accordance with some examples;

FIG. 3B is a diagram illustrating an interior perspective view of a containerized data center unit for edge computing deployments, in accordance with some examples;

FIG. 4 is a diagram illustrating an example of an edge computing system for machine learning (ML) and/or artificial intelligence (AI) workloads, where the edge computing system includes one or more local sites each having one or more containerized edge data center units, in accordance with some examples;

FIG. 5 is a block diagram illustrating an example architecture of a rapid response containerized edge data center unit that can be used for rapid response and/or emergency deployments to edge environments, in accordance with some examples;

FIG. 6A is a diagram illustrating a first configuration of a rapid response containerized edge data center unit including three compute racks, in accordance with some examples;

FIG. 6B is a diagram illustrating a second configuration of a rapid response containerized edge data center unit including two compute racks and a command/control station, in accordance with some examples;

FIG. 6C is a diagram illustrating a third configuration of a rapid response containerized edge data center unit including a compute rack and two command/control stations, in accordance with some examples;

FIG. 7 is a diagram illustrating an example of a communications engine that can be used to provide bonded satellite communication uplink and/or downlink using a plurality of satellite constellation transceivers, in accordance with some examples; and

FIG. 8 is a block diagram illustrating an example of a computing system architecture that can be used to implement one or more aspects described herein, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Systems and techniques are described herein for a containerized edge compute unit that is rapidly and efficiently deployable to network edge locations to provide emergency response functions and/or functionalities. For example, the containerized edge compute unit can be configured as a compact and ruggedized, modular containerized edge data center unit, capable of supporting various high-performance computational workloads (including various machine learning (ML) and/or artificial intelligence (AI) workloads) at the edge. The containerized edge compute unit can additionally provide various and multiple communications modalities to the edge environment in which it is deployed. For example, a rapid response containerized edge compute unit (e.g., a rapid response containerized edge data center unit) can be configured for rapid response deployment in various emergency situations, which can include, but are not limited to, natural disasters, power infrastructure outages or failures, search and rescue missions, environmental cleanups, large gatherings or events, etc., among other events and scenarios where existing infrastructure may be insufficient or unavailable.

In some aspects, the rapid response, containerized edge data center unit(s) described herein can be deployed to enable low-latency applications of high-performance computing at one or multiple edge locations (e.g., the location of a disaster event, emergency event, or other event or occurrence associated with a deployment of the rapid response containerized edge data center units described herein). The rapid response containerized edge data center unit(s) can additionally be used to enable various ML and/or AI workloads to be deployed at the remote edge, as well as to enable data sovereignty at the remote edge. Each containerized edge data center unit can be configured as a mobile, fully-integrated, enterprise-grade high-performance compute solution.

In some aspects, the rapid response containerized edge compute unit can be implemented using a modular form factor that comprises or is otherwise based on a 20-foot shipping container (e.g., a standardized shipping container housing can be used for the rapid response containerized edge compute unit, and may have a 20 foot length). For example, the rapid response containerized edge compute unit can be based on ISO-standardized intermodal shipping container dimensions.

The rapid response containerized edge data center unit disclosed herein can be configured with various modular designs and/or can be configured for stockpile integration (e.g., stockpile integration with various natural disaster, emergency event, or other rapid response resources that are staged or warehoused in one or more strategic locations prior to the occurrence of the disaster or rapid response event, for faster and more efficient deployment upon a later/subsequent occurrence of a natural disaster, emergency, or other rapid response event).

For example, the rapid response containerized edge data center unit described herein can be modular and can be integrated into or otherwise included in any emergency and disaster response stockpile, with multiple units stored in warehouses, parking lots, or distributed across various regions for easy access during disasters. The modular design of the rapid response containerized edge data center unit can allow the same, standardized container housing (e.g., 20-foot steel shipping container form factor of the housing, etc.) to be configured with different rack setups, including compute, high-performance compute, or a single rack with a desk/monitor console, tailored to specific requirements and pre-configured prior to delivery. Further details of different examples of the modular configurations of the same standardized container housing are described below with respect to the example configurations 610-1, 610-2, 610-3 of FIGS. 6A, 6B, 6C (respectively), each of which may be applied to and used to configure the example block architecture of the rapid response containerized edge data center unit 500 of FIG. 5, also described in greater detail below.

The rapid response containerized edge data center unit described herein can be designed for rapid deployment in various emergency situations, as noted above. The containerized edge data center unit can provide self-contained emergency response functionalities to the edge environment where the emergency, disaster, or other rapid response event has occurred (or is occurring). For example, the containerized edge data center unit can provide critical functionalities such as power generation and/or power supply/distribution, connectivity, communications, command and control capabilities, data storage and access/retrieval, etc. In some embodiments, the container size (e.g., housing size) of the rapid response containerized edge data center unit can be increased or decreased depending on a deployment or transportation modality intended for use in transporting the containerized edge data center unit to the location of a rapid response event (e.g., natural disaster, emergency, etc.).

For example, the containerized housing may be sized to fit on a flatbed truck for transportation to the rapid response event deployment site, etc. In some cases, the containerized housing may be sized to fit on a trailer or other towable frame or towable apparatus that can be towed by various commercial and/or passenger vehicles, trucks, SUVs, etc., for improved and enhanced mobility and easy of deployment for the rapid response containerized edge data center unit. In one illustrative example, the rapid response containerized infrastructure (e.g., containerized edge compute unit/data center) can be transported and/or deployed to an edge location corresponding to a rapid response or emergency event using one or more multiple modes of transportation. For instance, intermodal transportation can be used to move a rapid response containerized edge compute unit to a desired edge deployment site or location, based on the containerized housing using an ISO-standardized form factor compatible with intermodal shipping and transportation. Intermodal shipping (also referred to as intermodal freight transport) can involve transportation using multiple modes of transportation (e.g., rail/train, ship, aircraft, truck, etc.), without any additional handling of the freight itself when changing transportation modes. For instance, an intermodal shipping container can be offloaded from a cargo ship and placed directly onto an intermodal truck for delivery to a final destination, etc.

The rapid response containerized edge data center unit can provide self-contained and self-sustaining functionalities to support emergency response, command and control, and various other functionalities, services, activities, etc., that may be provided by first responders, emergency responders, and/or local officials associated with the site of the emergency, disaster, or other rapid response event. For example, the rapid response containerized edge data center unit can be configured to operate with or without a reliable connection to existing infrastructure (e.g., such as electrical infrastructure, communications infrastructure, cellular network infrastructure, internet infrastructure, etc.), as the existing infrastructure may either be unavailable (e.g., in remote edge locations), may be unreliable, may be damaged (e.g., damaged at least in part due to the disaster or other circumstances of the rapid response event for which the containerized edge data center unit is deployed), and/or various combinations thereof.

In some embodiments, the rapid response containerized edge data center unit can provide redundant and seamless integrated connectivity, power, and compute application hosting capabilities, locally at the edge deployment to the rapid response event. The deployment of the rapid response containerized edge data center unit can ensure that essential services remain accessible, including in challenging or hostile environments, conditions, emergency situations, etc., to first/emergency responders and/or to the local population. The rapid response containerized edge data center unit can support and provide multiple communication modalities, including cellular (e.g., 3G, 4G/LTE, 5G/NR, etc.) connectivity to both public and/or private cellular networks; satellite connectivity to public, private, first-party, third-party, etc., satellite communication network constellations; wired connectivity to existing internet backhaul or backbone infrastructure, where available; etc. The rapid response containerized edge data center unit can additionally, or alternatively, support and provide communications using one or more of a Long-Range Wide Area Network (LoRaWAN), a wireless Highway Addressable Remote Transducer (WirelessHART), narrowband internet-of-things (NB-IoT), Zigbee, Z-Wave, etc.

In some aspects, the rapid response containerized edge data center unit can provide (and, in some embodiments) combine multiple remote communication links or modalities to provide increased throughput or bandwidth, as well as to provide improved redundancy and resistance to failures or network outage events. In one illustrative example, the rapid response containerized edge data center unit can be configured to provide one or more local communication networks within the vicinity or surrounding environment of the rapid response containerized edge data center unit as deployed to the edge location within or corresponding to the rapid response event. For example, the rapid response containerized edge data center unit can provide one or more wired access networks, wireless local area network (WLAN) networks (e.g., based on IEEE 802.11 communication standards, etc.), etc., configured to support local communications within or associated with the physical location of rapid response event and the deployed rapid response edge compute unit. In some aspects, the rapid response edge compute unit can provide communications hub or communications relay functionality, enabling communications between the various devices used by local residents and first/emergency responders at the location of the rapid response event (e.g., intra-edge communications, facilitated or mediated by the rapid response edge compute unit and its one or more WLANs), as well as communications from the local edge/location of the rapid response event to the wider internet or other remote locations (e.g., inter-edge communications, facilitated or mediated by the rapid response edge compute unit acting as a relay or communications hub bridging between the WLANs at the rapid response event and one or more remote communication networks connected to the rapid response edge compute unit).

In addition to supporting multiple and redundant communications links, modalities, and/or networks, etc. to thereby provide and ensure reliable internet access for critical communications and data transmission, emergency notifications, etc., the rapid response containerized edge compute unit (e.g., interchangeably referred to herein as the rapid response containerized edge data center unit) can be configured with multiple and redundant power sources. For example, the rapid response containerized edge data center unit can support emergency response for essential service and critical infrastructure providers, each of which may require (or strongly benefit from) a constant or uninterrupted supply of electrical power, particularly in natural disasters or other rapid response events where the existing electric service and existing electrical infrastructure has been damaged, destroyed, or otherwise disrupted.

In one illustrative example, the rapid response containerized edge data center can be configured for connection with one or more electrical power supplies that are local to the edge environment or rapid response event location into which the containerized edge data center unit is deployed. For example, the rapid response containerized edge data center can be configured for connection to the local electrical grid or other local edge electrical infrastructure, when or where external power supply to the containerized edge unit is available.

The containerized edge unit may further be configured with one or more onboard or backup power supplies, including various generators and/or electrical generation systems or techniques (e.g., onboard or deployable solar panels, onboard or deployable electrical generators (e.g., diesel-powered combustion generators, etc.), wind turbines, etc.). The containerized edge data center unit may additionally, or alternatively, include one or more onboard or integrated energy storage systems, such as one or more battery banks or battery arrays that can be used to store electrical power (fed from the local grid, fed from the onboard generation capabilities, or both) and/or to distribute electrical power.

The rapid response containerized edge data center unit can utilize its power control module(s) (e.g., including connection to local electric infrastructure, any or all onboard or backup electrical generation provided by the edge data center unit, any or all onboard or backup electrical storage provided by batteries onboard the edge data center unit, etc.) to both provide electrical power for running the operations of the rapid response containerized edge data center unit itself, as well as to provide or distribute electrical power to one or more connected devices or apparatuses. For example, the deployed rapid response containerized edge data center unit can be configured to implement a power hub for local residents and/or emergency/first responders at the rapid response event, wherein the rapid response containerized edge data center unit includes one or more power distribution interfaces configured for use by the local residents, emergency and first responders, etc., to charge or otherwise power their various devices. In some aspects, the rapid response containerized edge data center can be configured or otherwise used to provide a step-up/step-down electrical transformer distribution system for converting an input voltage and/or phase of electrical power into a different output voltage and/or phase (e.g., where the output voltage and/or phase is associated with the electrical requirements of connected devices of the deployed rapid response containerized edge data center). In some examples, the rapid response containerized edge data center can include or otherwise implement one or more buck-boost transformers that can be used to reduce (e.g., buck) or raise (e.g., boost) the input voltage to a lower or higher output voltage, respectively. The power hub and/or power distribution capabilities of the deployed rapid response containerized edge data center unit can include the one or more transformers, as well as power cleaning or power conditioning equipment, in order for the deployed rapid response containerized edge data center unit to provide stable and uninterrupted power at a desired or configured voltage (e.g., 120V/240V/480V), a desired or configured amperage, a desired or configured phase, etc.

As will be described in greater depth below, the systems and techniques disclosed herein for a rapid response, containerized edge data center unit can be used to seamlessly integrate connectivity, power, and application-hosting capabilities at the network edge location of a rapid response event, natural disaster, or other emergency, thereby ensuring essential services remain accessible even in the most challenging environments and emergency situations. With integrated LTE and satellite connectivity (e.g., among various other integrated communication modalities, networks, transceivers, etc.), the disclosed rapid response, containerized edge data center unit can ensure reliable internet access between the location/site of the rapid response event and the wider world, such that critical communications and data transmissions can be both sent and/or received by personnel or other individuals at the site of the rapid response event. In some aspects, the rapid response containerized edge data center unit can be configured and used to support emergency response for essential service and critical infrastructure providers. As noted above, the rapid response containerized edge data center unit can include a robust and redundant power management/supply system, which may include one or more (or all) of solar panels, portable diesel generation, primary or secondary battery power systems, and/or battery backup systems, etc., which can be used to provide uninterrupted operation even in remote locations with limited and/or damaged power infrastructure.

As will also be described in greater depth herein, in at least some aspects, the rapid response containerized edge data center unit can be configured to can run (e.g., locally at the edge, with no remote/cloud communications or with minimal remote/cloud communications) a variety of high-performance and/or high-reliability emergency response, coordination, or command and control applications to support the ongoing rapid response. In some aspects, the rapid response containerized edge data center unit can provide local edge applications corresponding to various functionalities, from communication platforms to disaster response tools, thereby enabling quick and effective response during emergencies. In some embodiments, the local edge applications and/or compute tasks implemented by the rapid response containerized edge data center unit can include, but are not limited to, communication, coordination, and messaging apps for real-time communication among responders and agencies; mapping and navigation applications; localization and geospatial systems; resource allocation and inventory management apps; situational awareness tools for monitoring and analyzing real-time data on incidents; damage assessment and recovery systems; ML/AI applications for environment monitoring, security, and damage assessment; and/or back-end support or offloaded computation for real-time conversational assistance via hands-free headsets and smart glasses; etc. In some aspects, the rapid response containerized edge data center can include or implement one or more high-performance computing engines, and/or onboard edge computing hardware that can be used to provide accelerated computing for various ones of the local edge applications and compute tasks identified above. For example, the rapid response containerized edge data center can provide accelerated computing based on including one or more (or a plurality of) GPUs, FPGAs, multi-core CPUs, etc., that are configured to run inference using ML/AI applications in substantially real-time. IN some cases, the rapid response containerized edge data center can be configured to provide geospatial positioning for assistance for localization and mapping applications.

Further details regarding the systems and techniques described herein will be discussed below with respect to the figures.

FIG. 1 shows a block diagram of a design of a base station 102 and a UE 104 that enable transmission and processing of signals exchanged between the UE and the base station, in accordance with some aspects of the present disclosure. Design 100 includes components of a base station 102 and a UE 104. In some examples, the architecture of base station 102 can be the same as or similar to an architecture used to implement a satellite constellation ground station (e.g., internet gateway for providing internet connectivity via a satellite constellation). In some examples, the architecture of base station 102 can be the same as or similar to an architecture used to implement a satellite of a satellite constellation and/or a network entity in communication with a satellite constellation (e.g., such as the satellite constellations and/or networks depicted in FIGS. 2A and 2B).

As illustrated in FIG. 1, base station 102 may be equipped with T antennas 134a through 134t, and UE 104 may be equipped with R antennas 152a through 152r, where in general T≥1 and R≥1. At base station 102, a transmit processor 120 may receive data from a data source 112 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 120 may also process system information (e.g., for semi-static resource partitioning information (SRPI) and/or the like) and control information (e.g., CQI requests, grants, upper layer signaling, and/or the like) and provide overhead symbols and control symbols. Transmit processor 120 may also generate reference symbols for reference signals (e.g., the cell-specific reference signal (CRS)) and synchronization signals (e.g., the primary synchronization signal (PSS) and secondary synchronization signal (SSS))). A transmit (TX) multiple-input multiple-output (MIMO) processor 130 may perform spatial processing (e.g., precoding) on the data symbols, the control symbols, the overhead symbols, and/or the reference symbols, if applicable, and may provide T output symbol streams to T modulators (MODs) 132a through 132t. The modulators 132a through 132t are shown as a combined modulator-demodulator (MOD-DEMOD). In some cases, the modulators and demodulators can be separate components. Each modulator of the modulators 132a to 132t may process a respective output symbol stream, e.g., for an orthogonal frequency-division multiplexing (OFDM) scheme and/or the like, to obtain an output sample stream. Each modulator of the modulators 132a to 132t may further process (e.g., convert to analog, amplify, filter, and upconvert) the output sample stream to obtain a downlink signal. T downlink signals may be transmitted from modulators 132a to 132t via T antennas 134a through 134t, respectively. According to certain aspects described in more detail below, the synchronization signals can be generated with location encoding to convey additional information.

At UE 104, antennas 152a through 152r may receive the downlink signals from base station 102 and/or other base stations and may provide received signals to demodulators (DEMODs) 154a through 154r, respectively. The demodulators 154a through 154r are shown as a combined modulator-demodulator (MOD-DEMOD). In some cases, the modulators and demodulators can be separate components. Each demodulator of the demodulators 154a through 154r may condition (e.g., filter, amplify, downconvert, and digitize) a received signal to obtain input samples. Each demodulator of the demodulators 154a through 154r may further process the input samples (e.g., for OFDM and/or the like) to obtain received symbols. A MIMO detector 156 may obtain received symbols from all R demodulators 154a through 154r, perform MIMO detection on the received symbols if applicable, and provide detected symbols. A receive processor 158 may process (e.g., demodulate and decode) the detected symbols, provide decoded data for UE 104 to a data sink 160, and provide decoded control information and system information to a controller/processor 180. A channel processor may determine reference signal received power (RSRP), received signal strength indicator (RSSI), reference signal received quality (RSRQ), channel quality indicator (CQI), and/or the like.

On the uplink, at UE 104, a transmit processor 164 may receive and process data from a data source 162 and control information (e.g., for reports comprising RSRP, RSSI, RSRQ, CQI, and/or the like) from controller/processor 180. Transmit processor 164 may also generate reference symbols for one or more reference signals (e.g., based at least in part on a beta value or a set of beta values associated with the one or more reference signals). The symbols from transmit processor 164 may be precoded by a TX-MIMO processor 166 if application, further processed by modulators 154a through 154r (e.g., for DFT-s-OFDM, CP-OFDM, and/or the like), and transmitted to base station 102. At base station 102, the uplink signals from UE 104 and other UEs may be received by antennas 134a through 134t, processed by demodulators 132a through 132t, detected by a MIMO detector 136 if applicable, and further processed by a receive processor 138 to obtain decoded data and control information sent by UE 104. Receive processor 138 may provide the decoded data to a data sink 139 and the decoded control information to controller (e.g., processor) 140. Base station 102 may include communication unit 144 and communicate to a network controller 131 via communication unit 144. Network controller 131 may include communication unit 194, controller/processor 190, and memory 192. In some aspects, one or more components of UE 104 may be included in a housing. Memories 142 and 182 may store data and program codes for the base station 102 and the UE 104, respectively. A scheduler 146 may schedule UEs for data transmission on the downlink, uplink, and/or sidelink.

As noted previously, low-orbit satellite constellation systems have been rapidly developed and deployed to provide wireless communications and data network connectivity. A fleet of discrete satellites (also referred to as “birds”) can be arranged as a global satellite constellation that provides at least periodic or intermittent coverage to a large portion of the Earth's surface. In many cases, at least certain areas of the Earth's service may have continuous or near-continuous coverage from at least one bird of the satellite constellation. For instance, a global satellite constellation can be formed based on a stable (and therefore predictable) space geometric configuration, in which the fleet of birds maintain fixed space-time relationships with one another. A satellite constellation be used to provide data network connectivity to ground-based devices and/or other terrestrial receivers. For example, a satellite constellation can be integrated with or otherwise provide connectivity to one or more terrestrial (e.g., on-ground) data networks, such as the internet, a 4G/LTE network, and/or a 5G/NR network, among various others. In one illustrative example, a satellite internet constellation system can include a plurality of discrete satellites arranged in a low-earth orbit and used to provide data network connectivity to the internet.

To implement an internet satellite constellation, the discrete satellites can be used as space-based communication nodes that couple terrestrial devices to terrestrial internet gateways. The terrestrial internet gateways may also be referred to as ground stations, and are used to provide connectivity to the internet backbone. For instance, a given satellite can provide a first communication link to a terrestrial device and a second communication link to a ground station that is connected to an internet service provider (ISP). The terrestrial device can transmit data and/or data requests to the satellite over the first communication link, with the satellite subsequently forwarding the transmission to the ground station internet gateway (from which point onward the transmission from the device is handled as a normal internet transmission). The terrestrial device can receive data and/or requests using the reverse process, in which the satellite receives a transmission from the ground station internet gateway via the second communication link and then forwards the transmission to the terrestrial device using the first communication link.

Although an internet satellite constellation includes a fleet of discrete satellites, in some cases terrestrial devices connected with a satellite may communicate with a ground station/internet gateway that is also able to communicate with the same satellite. In other words, it is typically the case that the first and second communication links described above must be established with the same satellite of the satellite constellation. A user connecting to any particular satellite is therefore limited by the ground station/internet gateways that are visible to that particular satellite. For instance, a user connected to a satellite that is unable to establish a communication link with a ground station/internet gateway is therefore unable to connect to the internet—although the fleet of satellites is a global network in terms of spatial diversity and arrangement, the individual satellites function as standalone internet relay nodes unless an inter-satellite link capability is provided.

In some cases, inter-satellite links can allow point to point communications between the individual satellites included in a satellite constellation. For instance, data can travel at the speed of light from one satellite to another, resulting in a fully interconnected global mesh network that allows access to the internet as long as the terrestrial device can establish communication with at least one satellite of the satellite internet constellation. In one illustrative example, a satellite internet constellation can implement inter-satellite links as optical communication links. For example, optical space lasers can be used to implement optical intersatellite links (ISLs) between some (or all) of the individual birds of a satellite constellation. In this manner, the satellite internet constellation can be used to transmit data without the use of local ground stations, and may be seen to provide truly global coverage.

For instance, optical laser links between individual satellites in a satellite constellation can reduce long-distance latency by as much as 50%. Additionally, optical laser links (e.g., ISLs) can enable the more efficient sharing of capacity by utilizing the otherwise wasted satellite capacity over regions without ground station internet gateways. Moreover, optical laser links allow the satellite constellation to provide internet service (or other data network connectivity) to areas where ground stations are not present and/or are impossible to install.

To implement a satellite constellation, one or more satellites may be integrated with the terrestrial infrastructure of a wireless communication system. In general, satellites may refer to Low Earth Orbit (LEO) devices, Medium Earth Orbit (MEO) devices, Geostationary Earth Orbit (GEO) devices, and/or Highly Elliptical Orbit (HEO) devices. In some aspects, a satellite constellation can be included in or used to implement a non-terrestrial network (NTN). A non-terrestrial network (NTN) may refer to a network, or a segment of a network, that uses an airborne or spaceborne vehicle for transmission. For instance, spaceborne vehicles can refer to various ones of the satellites described above. An airborne vehicle may refer to High Altitude Platforms (HAPs) including Unmanned Aircraft Systems (UAS). An NTN may be configured to help to provide wireless communication in un-served or underserved areas to upgrade the performance of terrestrial networks. For example, a communication satellite (e.g., of a satellite constellation) may provide coverage to a larger geographic region than a terrestrial network base station. The NTN may also reinforce service reliability by providing service continuity for UEs or for moving platforms (e.g., passenger vehicles-aircraft, ships, high speed trains, buses). The NTN may also increase service availability, including critical communications. The NTN may also enable network scalability through the provision of efficient multicast/broadcast resources for data delivery towards the network edges or even directly to the user equipment.

FIG. 2A is a diagram illustrating an example configuration 200a of an NTN for providing data network connectivity to terrestrial (ground-based) devices. In one illustrative example, the NTN can be a satellite internet constellation, although various other NTNs and/or satellite constellation data network connectivity types may also be utilized without departing from the scope of the present disclosure. As used herein, the terms “NTN” and “satellite constellation” may be used interchangeably.

An NTN may refer to a network, or a segment of a network, that uses RF resources on-board an NTN platform. The NTN platform may refer to a spaceborne vehicle or an airborne vehicle. Spaceborne vehicles include communication satellites that may be classified based on their orbits. For example, a communication satellite may include a GEO device that appears stationary with respect to the Earth. As such, a single GEO device may provide coverage to a geographic coverage area. In other examples, a communication satellite may include a non-GEO device, such as an LEO device, an MEO device, or an HEO device. Non-GEO devices do not appear stationary with respect to the Earth. As such, a satellite constellation (e.g., one or more satellites) may be configured to provide coverage to the geographic coverage area. An airborne vehicle may refer to a system encompassing Tethered UAS (TUA), Lighter Than Air UAS (LTA), Heavier Than Air UAS (HTA) (e.g., in altitudes typically between 8 and 50 km including High Altitude Platforms (HAPs)).

A satellite constellation can include a plurality of satellites, such as the satellites 202, 204, and 206 depicted in FIG. 2A. The plurality of satellites can include satellites that are the same as one another and/or can include satellites that are different from one another. A terrestrial gateway 208 can be used to provide data connectivity to a data network 210. For instance, the terrestrial gateway 208 can be a ground station (e.g., internet gateway) for providing data connectivity to the internet. Also depicted in FIG. 2A is a UE 230 located on the surface of the earth, within a cell coverage area of the first satellite 202. In some aspects, the UE 230 can include various devices capable of connecting to the NTN 200a and/or the satellite constellation thereof for wireless communication.

The gateway 208 may be included in one or more terrestrial gateways that are used to connect the NTN 200a and/or satellite constellation thereof to a public data network such as the internet. In some examples, the gateway 208 may support functions to forward a signal from the satellite constellation to a Uu interface, such as an NR-Uu interface. In other examples, the gateway 208 may provide a transport network layer node, and may support various transport protocols, such as those associated with providing an IP router functionality. A satellite radio interface (SRI) may provide IP trunk connections between the gateway 208 and various satellites (e.g., satellites 202-206) to transport NG or F1 interfaces, respectively.

Satellites within the satellite constellation that are within connection range of the gateway 208 (e.g., within line-of-sight of, etc.) may be fed by the gateway 208. The individual satellites of the satellite constellation can be deployed across a satellite-targeted coverage area, which can correspond to regional, continental, or even global coverage. The satellites of the satellite constellation may be served successively by one or more gateways at a time. The NTN 200a associated with the satellite constellation can be configured to provide service and feeder link continuity between the successive serving gateways 208 with time duration to perform mobility anchoring and handover.

In one illustrative example, the first satellite 202 may communicate with the data network 210 (e.g., the internet) through a feeder link 212 established between the first satellite 202 and the gateway 208. The feeder link 212 can be used to provide bidirectional communications between the first satellite 202 and the internet backbone coupled to or otherwise provided by gateway 208. The first satellite 202 can communicate with the UE 230 using a service link 214 established within the cell coverage (e.g., field-of-view) area of an NTN cell 220. The NTN cell 220 corresponds to the first satellite 202. In particular, the first satellite 202 and/or service link 214 can be used to communicate with different devices or UEs that are located within the corresponding NTN cell 220 of first satellite 202.

More generally, a feeder link (such as feeder link 212) may refer to a wireless link between a gateway and a particular satellite of a satellite constellation. A service link (such as service link 214) may refer to a wireless link between a UE and particular satellite of a satellite constellation. In some examples, one or more (or all) of the satellites of a satellite constellation can use one or more directional beams (e.g., beamforming) to communicate with the UE 230 via service link 214 and/or to communicate with the ground station/internet gateway 208 via feeder link 212. For instance, the first satellite 202 may use directional beams (beamforming) to communicate with UE 230 via service link 214 and/or to communicate with gateway 208 via feeder link 212. A beam may refer to a wireless communication beam generated by an antenna on-board a satellite.

In some examples, the UE 230 may communicate with the first satellite 202 via the service link 214, as described above. Rather than the first satellite 202 then using the feeder link 212 to forward the UE communications to internet gateway 208, the first satellite 202 may instead relay the communication to second satellite 204 through an inter-satellite link (ISL) 216. The second satellite 204 can subsequently communicate with the data network 210 (e.g., internet) through a feeder link 212 established between the second satellite 204 and the internet gateway 208. In some aspects, the ISL links can be provided between a constellation of satellites and may involve the use of transparent payloads on-board the satellites. The ISL link may operate in an RF frequency or an optical band. In one illustrative example, the ISL links between satellites of a satellite constellation can be implemented as optical laser links (e.g., using optical space laser transceivers provided on the satellites), as was noted previously above.

In the illustrated example of FIG. 2A, the first satellite 202 may provide the NTN cell 220 with a first physical cell ID (PCI). In some examples, a constellation of satellites may provide coverage to the NTN cell 220. For example, the first satellite 202 may include a non-GEO device that does not appear stationary with respect to the Earth. For instance, the first satellite 202 can be a low-earth orbit (LEO) satellite included in a LEO satellite constellation for providing data network connectivity. As such, a satellite constellation (e.g., one or more satellites) may be configured to provide coverage to the NTN cell 220. For example, the first satellite 202, second satellite 204, and third satellite 206 may be part of a satellite constellation that provides coverage to the NTN cell 220.

In some examples, satellite constellation deployment may provide different services based on the type of payload onboard the satellite(s). The type of payload may determine whether the satellite acts as a relay node or a base station. For example, a transparent payload is associated with the satellite acting as a relay node, while a non-transparent payload is associated with the satellite acting as a base station. A transparent payload may implement frequency conversion and a radio frequency (RF) amplifier in both uplink (UL) and downlink (DL) directions and may correspond to an analog RF repeater. A transparent payload, for example, may receive UL signals from all served UEs and may redirect the combined signals DL to an earth station (e.g., internet gateway 208) without demodulating or decoding the signals. Similarly, a transparent payload may receive an UL signal from an earth station and redirect the signal DL to served UEs without demodulating or decoding the signal. However, the transparent payload may frequency convert received signals and may amplify and/or filter received signals before transmitting the signals.

A non-transparent payload may receive UL signals and demodulate or decode the UL signal before generating a DL signal. For instance, the first satellite 202 may receive UL signals from one or more served UEs (e.g., within the cell 220) and subsequently demodulate or decode the UL signals prior to generating one or more corresponding DL signals to the internet gateway 208. Similarly, the first satellite 202 may receive UL signals from the internet gateway 208 and subsequently demodulate or decode the UL signals prior to generating one or more corresponding DL signals to the served UEs within cell 220.

A satellite internet constellation is a fleet of satellite internet constellation satellites (also referred to as “birds”) arranged in a low-earth orbit (LEO). Satellite internet constellations can be implemented based on the idea that, with a sufficiently large constellation, at any given time at least one satellite should be sufficiently close to communicate with both a user satellite dish and a satellite dish at an internet gateway. In such implementations, the internet gateway satellite dish is typically located in the same general vicinity (e.g., geographic area) as the user satellite dish because, as noted previously above, the same satellite is used to communicate with both the internet gateway and the user. Based on the same satellite communicating with both the user and the internet gateway, the satellite can be used to route (e.g., relay) internet traffic between the customer and the internet via the internet gateway.

Advantageously, users of such satellite internet constellations can connect to the internet without the requirement of having a physical connection to the internet gateway (although it is noted that the description herein may be applied equally to standalone satellite internet connectivity and/or satellite internet connectivity that is combined with other connectivity means such as WiFi/wireless, cellular, fiber optic and other wired connections, etc.) Satellite internet users are typically connected to an internet gateway via a series of intermediate connections (also referred to as hops). In many cases, the direct physical connections between internet users and internet gateways are provided via internet service providers (ISPs), for example over fiber optic cables or copper lines. Satellite internet constellations (and the associated satellite internet service thereof) can be valuable for users for whom direct physical connections to an internet gateway are unavailable or otherwise prohibitively expensive. For instance, in some cases, users in rural or low density areas may not have access to the internet and/or may not have access to high-speed (e.g., fiber) internet because the cost of a ground-based physical connection to a gateway cannot be amortized over a sufficiently large quantity of users to justify the expense (e.g., as physical internet infrastructure is often built out by ISPs with the expectation of recouping the buildout cost via monthly internet service fees charged to its customers).

Satellite internet constellations and the associated satellite internet service (also referred to as “satellite internet connectivity” or “satellite connectivity”) can also be valuable as a backup or secondary communication link. For instance, satellite connectivity can be used to augment communications performed over a direct physical connections such as fiber, with a portion of communications routed over a fiber link and a portion of communications routed over a satellite connectivity link. The satellite connectivity link can be configured as a secondary link, a primary link, etc. The satellite connectivity link can additionally, or alternatively, be configured as a backup link for communications failover or fallback in case of a degradation or other interruption to a primary communication link (e.g., a primary finer link, etc.).

Satellite internet constellations can provide internet access to both users who are adequately served by conventional/existing physical ground-based internet connections and to users who are not adequately served (if served at all) by the existing physical ground-based internet connections. In some cases, geographic considerations beyond population density can also be an impediment to providing ground-based internet connectivity. For instance, island or archipelago geographies may be densely populated but have a landmass that is spread across numerous islands—in this case, it is logistically challenging and financially cumbersome to run fiber connections to all of the islands. Accordingly, geographic considerations can also act as a barrier to using conventional ground-based physical connections between users and internet gateways.

FIG. 2B is a diagram illustrating an example of a satellite internet constellation network 200b, which in some aspects can be used to provide low latency satellite internet connectivity to a plurality of users. The plurality of users can be associated with a corresponding plurality of UEs, such as the UE 230 depicted in FIG. 2B. The UE(s) 230 can include various different computing devices and/or networking devices. In some embodiments, the UEs 230 can include any electronic device capable of connecting to a data network such as the internet.

The UE 230 can be associated with a plurality of client-side satellite internet constellation dishes, shown here as the satellite dishes 212b, 214b, and 216b, although it is noted that a greater or lesser quantity of satellite dishes can be used without departing from the scope of the disclosure. In one illustrative example, the UE 230 and the satellite dishes 212b, 214b, 216b can be associated with one another based on a common or proximate geographic location, area, region, etc. In other words, it is contemplated that a plurality of client-side satellite internet constellation dishes can be deployed to serve (e.g., provide connectivity to the satellite internet constellation) various different geographic areas, with various granularities as desired. For example, a group of satellite dishes can be deployed in and around a city, a town, a region, etc. The groups of satellite dishes can also be deployed in rural areas (e.g., lower-density concentrations of users). Multiple satellite dishes may be connected the same Edge Compute Unit to offer redundancy and resilience against outage, high latency, or low bandwidth.

In some cases, one or more satellite dishes (and/or groups thereof) can be deployed in remote areas that are distant from population centers, and in particular, that are distant from various types of infrastructure (e.g., including but not limited to electrical/power connectivity, internet and/or communication networking, compute capacity, reach of skilled personnel, access to road transportation, etc.). The client-side satellite dishes 212b, 214b, 216b can communicate with a satellite internet constellation, shown in FIG. 2B as including a first satellite 202b, a second satellite 204b, a third satellite 206b, and a fourth satellite 204b. However, it is noted that a greater quantity of satellites can be used to implement the satellite internet constellation, with FIG. 2B presenting a simplified example for purposes of clarity of explanation.

Similarly, a plurality of server-side satellite internet constellation dishes 221, 223, 225 can be provided in association with various different gateways, such as the gateway 240 depicted in FIG. 2B. In some embodiments, the gateway 240 can be an internet gateway that provides connectivity to an internet backbone. In some aspects, the gateway 240 can be a data center or CDN that caches, hosts, stores, serves, or otherwise provides web content in response to receiving corresponding client requests for the content. It is again noted that a greater or lesser quantity of server-side satellite dishes can be utilized without departing from the scope of the present disclosure. As was described above with respect to the client-side satellite dishes 212b, 214b, 216b, the server-side satellite dishes 221, 223, 225 can be associated to a respective data center 240 based on a common or proximate geographic location, area, region, etc. In one illustrative example, the server-side satellite dishes 221, 223, 225 can be located at varying levels of proximity to the respective data center 240. For instance, an inner layer of server-side satellite dishes can include the satellite dishes 223 and 225, which may be provided at the closest physical distance to the data center 240. An outer layer of server-side satellite dishes can include at least the satellite dish 221, which is located at a greater distance away from the data center 240 relative to the inner layer dishes 223 and 225. In some embodiments, the outer layer satellite dishes can be communicatively coupled to the inner layer satellite dishes via a wired and/or wireless connection. For example, the outer layer server-side satellite dish 221 can be communicatively coupled to the inner layer server-side satellite dish 223 via a wireless microwave relay connection (among various other wireless/RF connections) and/or can be communicatively coupled to the inner layer server-side satellite dish 223 via a wired fiber connection.

By providing multiple different satellite dishes for communicating with the satellite internet constellation, at both the client-side associated with UE 230 and the server-side associated with datacenter 240, the systems and techniques described herein can increase the satellite constellation ground coverage area available to the UE 230 and to the datacenter 240. For instance, at the client-side associated with UE 230, the number of birds that are visible to or overhead the set of dishes 212b, 214b, 216b will almost always be greater than the number of birds that are visible to or otherwise overhead any individual one of the three client-side dishes 212b, 214b, 216b. Similarly, at the server-side associated with datacenter 240, the number of birds that are visible to or otherwise overhead the set of the three dishes 221, 223, 225 will almost always be greater than the number of birds that are visible to or otherwise overhead any individual one of the three server-side dishes 221, 223, 225.

The interconnecting of the satellite dishes at each respective client location and at each respective server location, when combined with a satellite internet constellation implement optical space lasers or other ISLs, can enable more direct connectivity between the UE 230 and the datacenter 240. For instance, the UE 230 may use satellite dish 212b to communicate with satellite 202b, via a service link 252. As illustrated, satellite 202b is out of range of the data center 240(e.g., satellite 202b cannot establish a feeder link with any of the server-side dishes 221, 223, 225). In a conventional satellite internet constellation without ISLs, UE 230 would therefore be unable to use satellite 202b to obtain internet connectivity with data center 240 (based on the requirement in conventional satellite internet constellations that the same bird be used to connect the UE and an internet gateway).

Here, however, the UE 230 is able to establish internet connectivity with datacenter 240 via a first ISL 262a between satellite 202b and satellite 204b, a second ISL 262b between satellite 204b and satellite 208b, and a feeder link from satellite 208b to the server-side satellite dish 223. Notably, the UE 230 can establish internet connectivity with data center 240 via multiple different ISL-based paths through one different sets of birds of the satellite internet constellation. For instance, a first path from UE 230 to datacenter 240 is the combined path 252-262a-262b-272 described above. At least a second path from UE 230 to datacenter 240 may also be utilized. For example, the server-side dish 216b can communicate with satellite 204b via a service link 254, satellite 204b can communicate with satellite 206b via ISL 264, and satellite 206b can communicate with server-side dish 221 via feeder link 274.

Various other paths from the UE 230 to the datacenter 240 can also be utilized, with the two example paths of FIG. 2B provided for purposes of example and illustration, and not intended as limiting. For instance, the UE 230 can establish internet connectivity with datacenter 240 using a combination of: a particular service link selected from a plurality of available service links between one of the client-side dishes 212b, 214b, 216b to one of the birds of the constellation; one or more particular ISLs selected from a plurality of available ISLs between various combinations of two or more birds of the constellation; and a particular feeder link selected from a plurality of available feeder links between one of the birds of the constellation to one of the server-side dishes 221, 223, 225.

FIG. 3A is a diagram illustrating an example perspective view of a containerized data center unit 300a for edge computing deployments, in accordance with some examples; and FIG. 3B is a diagram illustrating an interior perspective view of a containerized data center unit 300b for edge computing deployments, in accordance with some examples. In some embodiments, the containerized edge data center unit 300a of FIG. 3A can be the same as or similar to the containerized edge data center unit 300b of FIG. 3B.

As illustrated, the containerized edge data center unit 300a of FIG. 3A can include power distribution components 330a (e.g., also referred to as a power distribution system or module 330a), cooling or HVAC components 320a (e.g., also referred to as cooling/HVAC system or module 320a), and compute components or hardware 340a (e.g., also referred to as compute system or module 340a). Similarly, the containerized edge data center unit 300b of FIG. 3B can include power distribution components 330b that are the same as or similar to the power distribution components 330a of FIG. 3A; cooling/HVAC components 320b that are the same as or similar to the cooling/HVAC components 320a of FIG. 3A; and compute components 340b that are the same as or similar to the compute components 340a of FIG. 3A.

The containerized edge data center 300 can be configured to deliver enterprise-grade performance in remote environments with limited infrastructure and operations support. For instance, given remote deployment siting/locations, service calls (break-fix) service-level agreements (SLAs) may commonly extend to 24 hours or greater—and high-performance edge computing instances typically have a downtime tolerance that is significantly less than the service call or SLA window. Accordingly, it is contemplated that the containerized edge data center can be implemented with resiliency and redundancy to minimize or eliminate downtime, even in remote deployment locations, such that high-performance edge computing can be maintained without modification of existing service call or SLA response times. The containerized edge data center can provide deployment versatility in locales without constant (e.g., 24×7) support staff, without dedicated or conditioned spaces (e.g., without concrete pads, warehousing, sheltering, etc.), among various other deployment scenarios that typically are challenging for high-performance computing.

Critical infrastructure components of the containerized edge data center 300 can include one or more (or all) of the power distribution module 330, the cooling/HVAC module 320, and/or the compute module 340. Critical infrastructure may additionally, or alternatively, include HVAC, power distribution, control systems, environmental monitoring and control, etc. In one illustrative example, critical infrastructure components may be selected based upon ease and/or modularity of assembly, as well as constituent materials quality, so as to reduce or eliminate common failure modes that may be associated with conventional edge computing deployments. Sub-systems of the containerized edge data center 300 can include at least a portion of (or all of) one or more of the power distribution module 330, the cooling/HVAC module 320, and/or the compute module 340. In some embodiments, sub-systems of the containerized edge data center unit 300 can be selected based on serviceability by ubiquitous mechanical and electrical trades (e.g., containerized edge data center unit 300 can be designed to be serviceable in the field and/or at remote edge locations, without requiring specialized equipment, tools, knowledge, training, etc.).

In some aspects, containerized edge data center unit 300 can be implemented using a containerized and structural design (inside and out) that assumes or is at least compatible with a multiple deployment scenario or configuration (e.g., in which a particular containerized edge data center unit 300 is one of a plurality of containerized edge data center units 300 that are deployed within and included in an enterprise user's fleet). In some embodiments, the compute module 340 can include a plurality of compute hardware racks (e.g., 2×, 3×, 4×, 6×, etc., 42U (or other size) racks). In some embodiments, each server rack within the compute module 340 can be configured with base-isolation on a per-rack level to provide isolation on some (or all) compute and networking hardware during both shipping/transportation as well as during deployment at the remote edge location.

In some examples, commodity and/or third-party compute, storage, and/or networking hardware can be utilized to provide various hardware configurations of the containerized edge data center units 300. For instance, third-party or commodify bare metal components can be used as a baseline hardware configuration for the compute, storage, and/or networking hardware of the containerized edge data center units 300, and may be integrated with the ISO-conformal containerized housing at the time of manufacture. In some aspects, different configurations of the hardware of containerized edge data center units 300 can be provided, as noted previously above, based on factors such as industry use-case, edge deployment site or location characteristics, existing infrastructure and utility support or availability, etc. In some aspects, some (or all) of the hardware configuration for one or more of the power distribution components 330, cooling/HVAC components 320, and/or compute components 340 can be customizable based on configuration or selection preferences indicated by an end user or customer that will take delivery of a particular containerized edge data center unit 300. For example, an end user or customer request corresponding to a particular hardware configuration of a containerized edge data center unit 300 may correspond to a request for hyperconverged infrastructure (e.g., Dell, HP, Azure, etc., among various other examples). In some embodiments, at least a portion of the hardware components of the containerized edge data center unit 300 (e.g., at least a portion of one or more of the power distribution module 330, cooling/HVAC module 320, compute module 340, and/or various other systems or modules such as command and control, critical systems or environmental monitoring, etc.) may be custom-designed at the chassis and/or silicon layers of the containerized edge data center unit 300, thereby providing cost and/or performance advantages over commodity or third-party hardware implementations of like components.

A containerized edge data center unit 300 can be pre-configured at the factory (e.g., at the time of manufacture or end user build-out) with the corresponding communications hardware and/or software to support multiple and various types, modes, modalities, etc., of wired and/or wireless communication. For instance, the containerized edge data center unit 300 can include one or more networked communications modules to provide backhaul connectivity (e.g., from the containerized edge data center unit 300 to a cloud or public network such as the internet, etc.) and can include one or more networked communications modules to provide local network connectivity between the containerized edge data center unit 300 and one or more edge sensors or edge assets that are collocated with the containerized edge data center unit 300 at the same edge deployment site or location.

In one illustrative example, the containerized edge data center unit 300 can use a first set of one or more networked communications modules to provide wired or wireless backhaul data network connectivity. For instance, the backhaul can be an internet backhaul, which may be implemented using one or more of a fiber communication link (e.g., wired fiber optic connectivity from the local site/edge compute unit 300 to internet infrastructure that is connectable to a desired remote location or server; a direct or point-to-point wired fiber optic connectivity from the local site/edge compute unit 300 to the desired remote location or server; etc.). The internet backhaul may additionally, or alternatively, be implemented using one or more satellite communication links. For instance, internet backhaul can be a wireless communication link between edge compute unit 300 and a satellite of a satellite internet constellation. In some aspects, it is contemplated that the edge compute unit 300 can include (or otherwise be associated with) one or more satellite transceivers for implementing satellite connectivity to and/or from the edge compute unit 300. In some aspects, the one or more satellite transceivers can be integrated in or coupled to a housing (e.g., container, where edge compute unit 300 is a containerized data center) of the edge compute unit 300 and used to provide satellite connectivity capable of implementing the internet backhaul network capability. In another example, the one or more satellite transceivers can additionally, or alternatively, be provided at the local edge site where edge compute unit 300 is deployed.

The containerized edge data center unit 300 can use a second set of one or more networked communications modules to provide wired or wireless local data network connectivity between the containerized edge data center unit and various sensors, edge assets, IoT devices, and various other computing devices and/or networked devices that are associated with the same edge site deployment location as the containerized edge data center unit 300. For instance,

A local network connectivity module can be used to provide one or more communication links between the edge compute unit 300 and respective ones of a plurality of edge assets/sensors/devices etc. In one illustrative example, a local network connectivity module of the containerized edge compute unit 300 can be used to implement local network connectivity based on a private LTE, 3G, 5G or other private cellular network; based on a public LTE, 3G, 5G or other public cellular network; based on a WiFi, Bluetooth, Zigbee, Z-wave, Long Range (LoRa), Sigfox, Narrowband-IoT (NB-IoT), LTE for Machines (LTE-M), IPv6 Thread, or other short-range wireless network; based on a local wired or fiber-optic network; etc. The edge compute unit 300 can receive different types of data from different ones of the edge assets/sensors collocated at the same edge location (or otherwise associated with and communicatively coupled with the containerized edge compute unit 300) and can transmit different types of configurations/controls to different ones of the edge assets/sensors 310. For instance, the edge compute unit 300 can receive onboard camera feed and other sensor information (including SLAM sensor information) from one or more autonomous robots, drones, etc., and can transmit in response routing instructions to the autonomous robots or drones etc. in response. The routing instructions can be generated or otherwise determined based on processing the onboard camera feed data from the autonomous robots using an appropriate one (or more) trained AI/ML models deployed on or to the containerized edge compute unit 300 (e.g., deployed on or to the compute module 340).

In some embodiments, the compute module 340 of the containerized edge data center unit 300 can be configured as a combined compute and networking module or unit. The compute module/networking unit 340 of the containerized edge data center unit 300 can include computing hardware for providing edge computing and/or data services at the containerized edge data center unit 300. In one illustrative example, the compute/networking unit 340 (referred to interchangeably as a “compute unit” or a “networking unit” herein) can include a plurality of servers and/or server racks. As depicted in FIGS. 3A and 3B, the compute unit 340 can include a first server rack 345-1,a second server rack 345-2, . . . , and an nth server rack 345-n. The server racks can each include same or similar hardware. In some embodiments, different server racks of the plurality of server racks can each be associated with different hardware configurations.

In some embodiments, the server racks 345-1, . . . , 345-n can be implemented as conventional vertical server racks in which individual servers are vertically stacked atop one another. In other examples, the server racks 345-1, . . . , 345-n can be provided in a more horizontally distributed manner, either without maximizing the total available vertical space within the containerized housing of the edge compute unit 300 or with minimal vertical stacking of servers (or even no vertical stacking of servers). For instance, the server racks 345-1, . . . , 345-n may, in some aspects or implementations, comprise flattened implementations of standard vertical server racks, with a plurality of servers and/or motherboards spatially distributed across the horizontal surface area of the floor of the containerized housing of the edge compute unit 300. In some embodiments, each respective one of the server racks 345-1, . . . , 345-n (and/or some or all of the constituent servers or motherboards of each server rack, etc.) can be associated with or otherwise coupled to a corresponding one or more heatsinks and/or cooling means (e.g., included in the cooling/HVAC module(s) 320, etc.) for efficiently dissipating waste heat and maintaining high-performance computation. In some aspects, the server racks 345-1, . . . , 345-n may be implemented using horizontally distributed motherboards spread out along the bottom surface of the containerized housing of the containerized edge data center unit 300 and coupled to corresponding heatsinks on the bottom surface of the containerized housing.

In general, it is contemplated that the compute module 340 and/or the constituent server racks 345-1, . . . , 345-n can be configured to include various combinations of CPUs, GPUs, NPUs, ASICs, and/or various other computing hardware associated with a particular deployment scenario of the containerized edge computing apparatus 300. In some embodiments, the compute/networking unit 340 can include one or more data storage modules, which can provide onboard and/or local database storage using HDDs, SSDs, or combinations of the two. In some aspects, one or more server racks (of the plurality of server racks 345-1, . . . , 345-n) can be implemented either wholly or partially as data storage racks. In some examples, each respective server rack of the plurality of server racks 345-1, . . . , 345-n can include at least one data storage module, with data storage functionality distributed across the plurality of server racks 345-1, . . . ,345-n-n. In some embodiments, the compute/networking unit 340 can be configured to include multiple petabytes of SSD and/or HDD data storage, although greater or lesser storage capacities can also be utilized without departing from the scope of the present disclosure.

In some aspects, commodity-grade networking switches and/or network switching hardware can be included in the containerized edge data center unit 300 and used to support multiple connectivity modes and platforms (e.g., satellite internet constellation, ethernet/trench fiber, 5G or cellular), such that the containerized edge compute unit 300 is highly flexible and adaptable to all remote site conditions, bandwidth fluctuations, etc.

For instance, one or more communications or networking modules of the containerized edge data center unit 300 can be used to perform wired and/or wireless communications over one or more communications media or modalities. For example, a communications or networking module of the containerized edge data center unit 300 can be used to implement a data downlink (DL) and a data uplink (UL), for both internet/backhaul communications and for local network communications. In one illustrative example, a communications/networking module of the containerized edge data center unit 300 can include one or more satellite transceivers (e.g., also referred to herein as satellite dishes), such as a first satellite dish/transceiver and a second satellite dish/transceiver. In some embodiments, each respective satellite transceiver of the one or more satellite transceivers can be configured for bidirectional communications (e.g., capable of receiving via data downlink and capable of transmitting via data uplink). In some aspects, a first satellite transceiver may be configured as a receiver only, with a remaining satellite transceiver configured as a transmitter only. Each of the satellite transceivers of the containerized edge data center unit 300 can communicate with one or more satellite constellations.

In some embodiments, a communications module of the containerized edge data center unit 300 can include an internal switching, tasking, and routing sub-system that is communicatively coupled to the networked communications modules and used to provide a network link thereof to the containerized edge data center unit 300. Although not illustrated, it is appreciated that the communications module and/or the internal switching, tasking, and routing sub-system(s) thereof can be configured to provide network links to one or more (or all) of the remaining components of the containerized edge data center unit 300, for example to provide control commands from a remote user or operator. In some cases, the communications module can include one or more antennas and/or transceivers for implementing communication types other than the satellite data network communications implemented via the one or more satellite transceivers and associated satellite internet constellations. For instance, the communications module(s) of the containerized edge data center unit 300 can include one or more antennas or transceivers for providing beamforming radio frequency (RF) signal connections. In some embodiments, beamforming RF connections can be utilized to provide wireless communications between a plurality of containerized edge data center units 300 that are within the same general area or otherwise within radio communications range. In some examples, a plurality of beamforming RF connections formed between respective pairs of the containerized edge data center units 300 can be used as an ad-hoc network to relay communications to a ground-based internet gateway. For example, beamforming RF radio connections can be used to relay communications from various containerized edge data center units 300 to one or more ground-based internet gateways that would otherwise be reachable via the satellite internet constellation (e.g., beamforming RF radio relay connections can be used as a backup or failover mechanism for the containerized edge data center unit 300 to reach an internet gateway when satellite communications are unavailable or otherwise not functioning correctly). In some aspects, local radio connections between the containerized edge data center units 300 can be seen to enable low latency connectivity between a plurality (e.g., a fleet) of the containerized edge data center units 300 deployed within a given geographical area or region.

In one illustrative example, various functionalities described above and herein with respect to the containerized edge data center unit 300 can be distributed over the particular units included in a given fleet. For instance, each containerized edge data center unit 300 may include an RF relay radio or various other transceivers for implementing backhaul or point-to-point links between the individual units included in the fleet. However, in some examples only a subset of the containerized edge data center units 300 included in a fleet may need to be equipped with satellite transceivers for communicating with a satellite internet constellation. For instance, a containerized edge data center unit 300 that does not include satellite transceivers may nevertheless communicate with the satellite internet constellation by remaining within RF relay range of one or more containerized edge data center units 300 that do include a satellite transceiver.

FIG. 4 is a diagram illustrating an example of an edge computing system 400 that can be associated with and/or can be used to implement or perform one or more aspects of the present disclosure. In some embodiments, the edge compute unit 430 can also be referred to as an “edge device.” In some aspects, edge compute unit 430 can be provided as a high-performance compute and storage (HPCS) and/or elastic-HPCS (E-HPCS) edge device.

For example, a local site 402 can be one of a plurality of edge environments/edge deployments associated with edge computing system 400. The plurality of local sites can include the local site 402 and some quantity N of additional local sites 402-N, each of which may be the same as or similar to the local site 402. The local site 402 can be a geographic location associated with an enterprise user or other user of edge computing. The local site 402 can also be an edge location in terms of data network connectivity (i.e., edge environment 402 is both a local geographic location of an enterprise user and is an edge location in the corresponding data network topography).

In the example of FIG. 4, the edge environment 402 includes one or more edge compute units 430. Each edge compute unit 430 can be configured as a containerized edge compute unit or data center for implementing sensor data generation or ingestion and inference for one or more trained ML/AI models provided on the edge compute unit 430. For instance, edge compute unit 430 can include computational hardware components configured to perform inference for one or more trained AI/ML models. As illustrated, a first portion of the edge compute unit 430 hardware resources can be associated with or used to implement inference for a first AI/ML model 435-1, . . . ,and an N^{th} AI/ML model 435-N. In other words, the edge compute unit 430 can be configured with compute hardware and compute capacity for implementing inference using a plurality of different AI/ML models. Inference for the plurality of AI/ML models can be performed simultaneously or in parallel for multiple ones of the N AI/ML models 435-1, . . . 435-N. In some aspects, inference can be performed for a first subset of the N AI/ML models for a first portion of time, can be performed for a second subset of the N AI/ML models for a second portion of time, etc. The first and second subsets of the AI/ML models can be disjoint or overlapping.

In some aspects, the edge compute unit 430 can be associated with performing one or more (or all) of on-premises training (or retraining) of one or more AI/ML models of the plurality of AI/ML models, performing fine-tuning of one or more AI/ML models of the plurality of AI/ML models, and/or performing instruction tuning of one or more AI/ML models of the plurality of AI/ML models. For instance, a subset of the plurality of AI/ML models that are deployed to (or are otherwise deployable to) the edge compute unit 430 may be trained or fine-tuned on-premises at the local edge site 402, without any dependence on the cloud (e.g., without dependence on the cloud-based AI/ML training clusters implemented within the cloud user environment 470). In some aspects, the edge compute unit 430 can perform the on-premises training or retraining, fine-tuning, and/or instruction tuning of the one or more AI/ML models of the plurality of AI/ML models to account for model degradation or drift over time. In some examples, the edge compute unit 430 can perform the one-premises training or retraining, fine-tuning, and/or instruction tuning of the one or more AI/ML models of the plurality of AI/ML models in order to adapt a respective AI/ML model to a new or differentiated task from which the respective model was originally trained (e.g., pre-trained).

In some cases, fine-tuning of an AI/ML model can be performed in the cloud (e.g., using the cloud-based AI/ML training clusters implemented within the cloud user environment 470), can be performed at the edge (e.g., at local edge environment 402, using edge compute unit 430 and AI/ML model finetuning 434-1, . . . , 434-M), and/or can be performed using a distributed combination over the cloud and one or more edge compute units 430. In some cases, fine-tuning of an AI/ML model can be performed in either the cloud or the edge environment 402 (or both), based on the use of significantly less compute power and data to perform finetuning and/or instruction tuning of a trained AI/ML model to a specific task, as compared to the compute power and data needed to originally train the AI/ML model to either the specific task or a broader class of tasks that includes the specific task.

In some embodiments, edge compute unit 430 can include computational hardware components that can be configured to perform training, retraining, finetuning, etc., for one or more trained AI/ML models. In some aspects, at least a portion of the computational hardware components of edge compute unit 430 used to implement the AI/ML model inference 435-1, . . . ,435-N can also be utilized to perform AI/ML model retraining 433-1, . . . , 433-K and/or to perform AI/ML model finetuning 434-1, . . . , 434-M. For example, computational hardware components (e.g., CPUs, GPUs, NPUs, hardware accelerators, etc.) included in the edge compute unit 430 may be configured to perform various combinations of model inference, model retraining, and/or model finetuning at the edge (e.g., at the local edge site 402). At least a portion of the K AI/ML models 433-1, . . . , 433-K associated with model retraining at the edge can be included in the N AI/ML models associated with model inference at the edge. Similarly, at least a portion of the M AI/ML models 434-1, . . . , 434-M associated with model finetuning at the edge can be included in the N AI/ML models associated with model inference at the edge.

In some embodiments, for a given pre-trained AI/ML model received at the edge compute unit 430 (e.g., received from the AI/ML training clusters in the cloud user environments 470), the edge compute unit 430 can be configured to perform one or more (or all) of model inference 435, model retraining 433, and/or model finetuning 434 at the edge.

As illustrated in FIG. 4, retraining for a plurality of AI/ML models can be performed simultaneously or in parallel for multiple ones of the K AI/ML models 433-1, . . . , 433-K (which as noted above can be the same as or similar to the N AI/ML models 435-1, . . . , 435-N, or may be different; and/or can be the same as or similar to the M AI/ML models 434-1, . . . , 434-M, or may be different). In some aspects, retraining can be performed for a first subset of the K AI/ML models for a first portion of time, can be performed for a second subset of the K AI/ML models for a second portion of time, etc. The first and second subsets of the K AI/ML models can be disjoint or overlapping. Additionally, or alternatively, finetuning for a plurality of AI/ML models can be performed simultaneously or in parallel for multiple ones of the M AI/ML models 434-1, . . . , 434-M (which can be the same as, similar to, or disjoint from the N AI/ML models 435 and/or the K AI/ML models 433). In some aspects, finetuning can be performed for a first subset of the M AI/ML models for a first portion of time, can be performed for a second subset of the M AI/ML models for a second portion of time, etc. The first and second subsets of the M AI/ML models can be disjoint or overlapping.

Each edge compute unit 430 of the one or more edge compute units provided at each edge environment 402 of the plurality of edge environments 402-N can additionally include cloud services 432, a high-performance compute (HPC) engine 434, and a local database 436. In some aspects, HPC engine 434 can be used to implement and/or manage inference associated with respective ones of the trained AI/ML models 435-1, . . . , 435-N provided on the edge compute unit 430.

In one illustrative example, the edge compute unit 430 can receive the trained AI/ML models 435-1, . . . , 435-N from a centralized AI/ML training cluster or engine that is provided by one or more cloud user environments 470. The AI/ML training clusters of the cloud user environment 470 can be used to perform training (e.g., pre-training) of AI/ML models that can later be deployed to the edge compute unit 430 for inference and/or other implementations at the edge environment 402. Data network connectivity between edge compute unit 430 and cloud user environments 470 can be provided using one or more internet backhaul communication links 440. For instance, the internet backhaul 440 can be implemented as a fiber communication link (e.g., wired fiber optic connectivity from the edge environment 402/edge compute unit 430 to internet infrastructure that is connectable to the cloud user environments 470; a direct or point-to-point wired fiber optic connectivity from the edge environment 402/edge compute unit 430 to the cloud user environments 470; etc.).

The internet backhaul 440 may additionally, or alternatively, be implemented using one or more satellite communication links. For instance, internet backhaul 440 can be a wireless communication link between edge compute unit 430/edge environment 402 and a satellite of a satellite internet constellation. In some aspects, it is contemplated that the edge compute unit 430 can include (or otherwise be associated with) one or more satellite transceivers for implementing satellite connectivity to and/or from the edge compute unit 430. In some aspects, the one or more satellite transceivers can be integrated in or coupled to a housing (e.g., container, in examples where edge compute unit 430 is a containerized data center) of the edge compute unit 430 and used to provide satellite connectivity capable of implementing the internet backhaul link 440. In another example, the one or more satellite transceivers can additionally, or alternatively, be provided at the edge environment 402 where edge compute unit 430 is deployed.

In some aspects, the internet backhaul link 440 between edge compute unit 430 and cloud user environments 470 can be used to provide uplink (e.g., from edge compute unit 430 to cloud user environments 470) of scheduled batch uploads of information corresponding to one or more of the AI/ML models 435-1, . . . , 435-N implemented by the edge compute unit 430, corresponding to one or more features (intermediate or output) generated by the AI/ML models implemented by edge compute unit 430, and/or corresponding to one or more sensor data streams generated by edge assets 410 provided at edge environment 402 and associated with the edge compute unit 430, etc. The internet backhaul link 440 may additionally be used to provide downlink (e.g., from cloud user environments 470 to edge compute unit 430) of updated, re-trained, fine-tuned, etc., AI/ML models. For instance, the updated, re-trained, or fine-tuned AI/ML models transmitted over internet backhaul link 440 from cloud user environments 470 to edge compute unit 430 can be updated, re-trained, or fine-tuned based on the scheduled batch upload data transmitted on the uplink from edge compute unit 430 to cloud user environments 470. In some aspects, the updated AI/ML models transmitted from cloud user environments 470 to edge compute unit 430 can be updated versions of the same AI/ML models 435-1, . . . , 435-N already implemented on the edge compute unit 430 (e.g., already stored in local database 436 for implementation on edge compute unit 430). In other examples, the updated AI/ML models transmitted from cloud user environments 470 to edge compute unit 430 can include one or more new AI/ML models that are not currently (and/or were not previously) included in the set of AI/ML models 435-1, . . . , 435-N that are either implemented on edge compute unit 430 or stored in local database 436 for potential implementation on edge compute unit 430.

In some cases, the AI/ML distributed computation platform 400 can use the one or more edge compute units 430 provided at each edge environment 402 to perform local data capture and transmission. In particular, the locally captured data can be obtained from one or more local sensors and/or other edge assets 410 provided at the edge environment 402. For instance, in the example of FIG. 4, the local edge assets/sensors 402 can include, but are not limited to, one or more autonomous robots 416, one or more local site cameras 414, one or more environmental sensors 412, etc. The local sensors and edge assets 410 can communicate with the edge compute unit 430 via a local network 420 implemented at or for edge environment 402.

In another example, the edge compute unit 430 can receive local camera feed(s) information from the local site cameras 414 and can transmit in response camera configuration and/or control information to the local site cameras 414. In some cases, the edge compute unit 430 may receive the local camera feed(s) information from the local site cameras 414 and transmit nothing in response. For instance, the camera configuration and/or control information can be used to re-position or re-configure one or more image capture parameters of the local site cameras 414if no re-positioning or image capture parameter reconfiguration is needed, the edge compute unit 430 may not transmit any camera configuration/control information in response. In some aspects, the camera configuration and/or control information can be generated or otherwise determined based on processing the local camera feed data from the local site cameras 414 using an appropriate one (or more) of the trained AI/ML models 435-1, . . . , 435-N implemented on the edge compute unit 430 and/or using the HPC engine 434 of the edge compute unit 430.

In another example, the edge compute unit 430 can receive environmental sensor data stream(s) information from the environmental sensors 412 and can transmit in response sensor configuration/control information to the environmental sensors 412. In some cases, the edge compute unit 430 may receive the sensor data streams information from the environmental sensors 412 and transmit nothing in response. For instance, the sensor configuration and/or control information can be used to adjust or re-configure one or more sensor data ingestion parameters of the environmental sensors 412—if no adjustment or re-configuration of the environmental sensors 412 is needed, the edge compute unit 430 may not transmit any sensor configuration/control information in response. In some aspects, the sensor configuration and/or control information can be generated or otherwise determined based on processing the local environmental sensor data streams from the environmental sensors 412 using an appropriate one (or more) of the trained AI/ML models 435-1, . . . , 435-N implemented on the edge compute unit 430 and/or using the HPC engine 434 of the edge compute unit 430.

In some examples, the systems and techniques described herein can be used to drive local storage, inference, prediction, and/or response, performed by an edge compute unit (e.g., edge compute unit 430) with minimal or no reliance on cloud communications or cloud offloading of the computational workload (e.g., to cloud user environments 470). The edge compute unit 430 can additionally be used to locally perform tasks such as background/batch data cleaning, ETL, feature extraction, etc. The local edge compute unit 430 may perform inference and generate prediction or inference results locally, for instance using one or more of the trained (e.g., pre-trained) AI/ML models 435-1, . . . , 435-N received by edge compute unit 430 from cloud user environments 470. The local edge compute unit 430 may perform further finetuning or instruction tuning of the pre-trained model to a specified task (e.g., corresponding one or more of the AI/ML model finetuning instances 433-1, . . . , 4333-M, as described previously above).

The prediction or inference results (and/or intermediate features, associated data, etc.) can be compressed and periodically uploaded by edge compute unit 430 to the cloud or other centralized location (e.g., such as cloud user environments 470 etc.). In one illustrative example, the compressed prediction or inference results can be uploaded to the cloud via a satellite communication link, such as a communication link to a satellite internet constellation configured to provide wireless satellite connectivity between the edge compute unit and existing terrestrial internet infrastructure. For instance, the compressed prediction or inference results can be included in the scheduled batch uploads transmitted over internet backhaul link 440 from edge compute unit 430 to cloud user environments 470. In some cases, the prediction or inference results can be utilized immediately at the edge compute unit 430, and may later be transmitted (in compressed form) to the cloud or centralized location (e.g., cloud user environments 470). In some aspects, satellite connectivity can be used to provide periodic transmission or upload of compressed prediction or inference results, such as periodic transmission during high-bandwidth or low-cost availability hours of the satellite internet constellation. In some cases, some (or all) of the compressed prediction or inference results can be transmitted and/or re-transmitted using wired or wireless backhaul means where available, including fiber-optic connectivity for internet backhaul, etc.

Notably, the systems and techniques can implement the tasks and operations described above locally onboard one or more edge compute units 430, while offloading more computationally intensive and/or less time-sensitive tasks from the edge compute unit to AI/ML training clusters in the cloud user environments 470. For instance, the AI/ML training clusters can be used to provide on-demand AI/ML model training and fine tuning, corresponding to the updated AI/ML models shown in FIG. 4 as being transmitted from cloud user environments 470 to edge compute unit 430 via internet backhaul 440. In some aspects, the AI/ML training clusters can implement thousands of GPUs or other high-performance compute hardware, capable of training or fine-tuning an AI/ML model using thousands of GPUs for extended periods of time (e.g., days, weeks, or longer, etc.). In some aspects, AI/ML training clusters can additionally, or alternatively, be used to perform on-cloud model compression and optimization prior to transmitting data indicative of the trained AI/ML models 435-1, . . . , 435-N to the edge compute unit 430 for local implementation using the sensor data generated by the associated edge assets 410. In some embodiments, the edge compute unit 430 can be configured to perform a scheduled or periodic download of fresh (e.g., updated or new) AI/ML models from AI/ML training clusters 470 via the internet backhaul link 440 (e.g., the updated or new AI/ML models can be distributed from AI/ML training clusters in the cloud user environments 470 to edge compute unit 430 in a pull fashion). In other examples, the updated or new AI/ML models can be distributed from AI/ML training clusters in the cloud user environments 470 to edge compute unit 430 in a push fashion, wherein the AI/ML training clusters 470 transmit the updated or new models to the edge compute unit 430 via internet backhaul link 440 as soon as the updated or new AI/ML model becomes available at the AI/ML training clusters.

Training the AI/ML models 435-1, . . . , 435-N may require massive amounts of data and processing power, which can be more efficiently implemented at the cloud user environments 470(and shared across the plurality of edge environment 402-N edge compute units 430) rather than implementing individually at each of the edge environments 402-N and corresponding edge compute unit(s) 430. In some aspects, the quality of an AI/ML model can be directly correlated with the size of the training and testing (e.g., validation) data used to perform the training and subsequent finetuning. Furthermore, in many cases, training large AI/ML models requires running thousands of GPUs, ingesting hundreds of terabytes of data, and performing these processes over the course of several weeks. Accordingly, in many cases, large-scale ML/AI model training is suited best for cloud or on-premises infrastructure and sophisticated MLOps. For instance, the training dataset associated with training a large-scale AI/ML model can be on the order of hundreds of TB-tens of petabytes (PB), or even larger. Thousands of GPUs and hours to weeks of training time can be needed, with the resulting size of the uncompressed, trained model exceeding hundreds or thousands of GB.

ML or AI inference (e.g., inference using a trained ML or AI model), on the other hand, can be implemented using far fewer resources than training, and may performed efficiently at the edge (e.g., by edge compute unit(s) 430 associated with the local site(s) 402 or 402-N). Indeed, in many cases, edge inferencing will provide better latency than cloud inferencing, as input sensor data generated at the edge (e.g., using edge assets 410) does not need to transit over an internet backhaul link 440 to the cloud region (e.g., cloud user environments 470 associated with the AI/ML training clusters) before inference can begin. Accordingly, it is contemplated herein that the trained AI/ML models 435-1, . . . , 435-N can be created and trained in the cloud (e.g., at AI/ML training clusters implemented within the cloud user environment 470), and additionally can be optimized and compressed significantly, enabling the systems and techniques described herein to distribute the optimized, compressed, and trained AI/ML models 435-1, . . . , 435-N to the edge locations associated with local sites 402 and corresponding edge compute unit(s) 430 where the optimized, compressed, and trained AI/ML models will be implemented for inferencing at the edge using local sensor data from edge assets 410. As noted previously above, in some aspects, one or more of the trained models (e.g., one or more of the trained AI/ML models 435-1, . . . , 435-N deployed to the edge compute unit 430 for local edge inference) can be fine-tuned or instruction tuned to specific tasks, a technique which requires significantly less data and compute than their training. For instance, a trained (e.g., pre-trained) AI/ML model can be fine-tuned or instruction tuned to specific tasks including new and/or differentiated tasks relative to the task(s) originally or previously corresponding to the trained model. In some examples, a trained (e.g., pre-trained) AI/ML model can be fine-tuned or instruction tuned to specific tasks using one or more of the model retraining instances 433-1, . . . , 433-K and/or using one or more of the model finetuning instances 434-1, . . . , 434-M implemented locally by the edge compute unit 430, as also described previously above.

For instance, the edge compute unit 430 can use one or more of the trained AI/ML models 435-1, . . . , 435-N to perform edge inferencing based on input data comprising the locally/edge-generated sensor data streams obtained from the edge assets 410 provided at the same edge environment 402 as the edge compute unit 430. In some aspects, the input data set for edge inferencing performed by edge compute unit 430 can comprise the real-time data feed from edge assets/sensors 410, which can be between tens of Mbps to 10 s of Gbps (or greater). The edge compute unit 430 can, in at least some embodiments, include 10 s of GPUs for performing local inferencing using the trained AI/ML models 435-1, . . . , 435-N. By performing local inferencing at edge compute unit 430, an inference response time or latency on the order of milliseconds (ms) can be achieved, significantly outperforming the inference response time or latency achievable using cloud-based or on-premises remote inferencing solutions.

In some aspects, the systems and techniques can be configured to implement a continuous feedback loop between edge compute unit(s) 430 and AI/ML training clusters in the cloud user environments 470. For instance, the continuous feedback loop can be implemented based on using the edge compute unit(s) and associated edge assets/sensors 410 to capture data locally, perform inference locally, and respond (e.g., based on the inference) locally. The edge compute unit(s) 430 can be additionally used to compress and transmit features generated during inference from the source data and/or to compress and transmit inference results efficiently to the AI/ML training clusters in the cloud user environments 470 (among other cloud or on-premises locations). In the continuous feedback loop, training and fine-tuning can subsequently be performed in the cloud, for instance by AI/ML training clusters and using the batch uploaded sensor data and/or features uploaded by the edge compute unit(s) 430 to AI/ML training clusters. Based on the training and fine-tuning performed in the cloud by the AI/ML training clusters, new or updated AI/ML models are distributed from the AI/ML training clusters back to the edge (e.g., to the edge compute unit(s) 430 and local site(s) 402). This continuous feedback loop for training and fine-tuning of AI/ML models can be seen to optimize the usage of cloud, edge, and bandwidth resources. The same AI/ML model may be finetuned across multiple edge nodes to optimize the usage of available compute at the nodes and the cloud. For instance, an AI/ML model can be finetuned across a set of edge nodes comprising at least the edge compute unit 430 and one or more edge compute units included in the additional local edge sites 402-N. In some cases, the distributed finetuning of an AI/ML model across multiple edge nodes can be mediated, supervised, and/or controlled, etc., by the AI/ML training clusters implemented within the cloud user environment 470 (e.g., or various other cloud entities). In some examples, the distributed finetuning of an AI/ML model across multiple edge nodes can be supervised and/or controlled, etc., by a selected one or more edge nodes of the set of edge nodes associated with the distributed finetuning of the model. In one illustrative example, distributed finetuning or retraining of an AI/ML model across multiple edge nodes can be orchestrated by a respective fleet management client that is implemented at or by each of the multiple edge nodes.

As noted previously, systems and techniques are provided herein for a rapid response containerized edge data center unit that is rapidly and efficiently deployable to network edge locations (e.g., locations corresponding to natural disasters, emergencies, or various other rapid response events) to provide emergency response functions and/or functionalities. The rapid response containerized edge data center unit is also referred to interchangeably herein as a rapid response containerized edge compute unit and/or a rapid response edge unit, etc.

For example, the rapid response edge unit can be configured as a compact and ruggedized, modular containerized edge data center unit, capable of supporting various high-performance and/or low-latency computational workloads (including various machine learning (ML) and/or artificial intelligence (AI) workloads) at the edge location of the emergency or other rapid response event. The containerized edge compute unit can additionally provide various and multiple communications modalities to the edge environment in which it is deployed. For example, a rapid response containerized edge compute unit (e.g., a rapid response containerized edge data center unit) can be configured for rapid response deployment in various emergency situations, which can include, but are not limited to, natural disasters, power infrastructure outages or failures, large gatherings or events, etc., among other events and scenarios where existing infrastructure may be insufficient or unavailable (collectively referred to herein as a “rapid response event” or “rapid response events”). In some aspects, a rapid response event may additionally, or alternatively, include various situations and/or scenarios in which rapid deployment of a command and control center with high compute and connectivity capabilities is needed.

FIG. 5 is a block diagram illustrating an example architecture of a rapid response containerized edge data center unit 500 that can be used for rapid response and/or emergency deployments to edge environments and/or for or in response to one or more rapid response events, in accordance with some examples.

In some aspects, the rapid response containerized edge data center unit 500 of FIG. 5 can be the same as or similar to the edge compute unit (e.g., containerized edge data center unit) 430 described previously above with respect to FIG. 4. In some aspects, the rapid response containerized edge data center unit 500 of FIG. 5 can be the same as or similar to one or more (or all) of the rapid response containerized edge data center unit 610-1 of FIG. 6A, 610-2 of FIG. 6B, and/or 610-3 of FIG. 6C.

In one illustrative example, the rapid response containerized edge data center unit 500 can be implemented using a containerized housing with a standardized and/or modular form factor. For example, the containerized housing of the rapid response containerized edge data center unit 500 can comprise a housing that encloses a volume that includes the various components, modules, engines, etc., of the rapid response containerized edge data center unit 500. For instance, the containerized housing can define a volume that encloses and/or includes the power control module 540, the emergency response engine 560, the compute engine 530, the communications engine 520, the local/private network node 510, and/or the peripheral devices 580 of the architecture shown for the rapid response containerized edge data center unit 500 of FIG. 5.

In some embodiments, the rapid response containerized edge compute unit 500 can be implemented using a modular form factor that comprises or is otherwise based on a 20-foot shipping container (e.g., a standardized shipping container housing can be used for the rapid response containerized edge compute unit 500, and may have a 20 foot length). For instance, the rapid response containerized edge compute unit 500 can be implemented using a 20 foot, steel shipping container housing that is environmentally sealed and/or ruggedized to protect or otherwise isolate the various internal components (e.g., the power control module 540, the emergency response engine 560, the compute engine 530, the communications engine 520, the local/private network node 510, and/or the peripheral devices 580, etc.) from heat, moisture, dust, debris, or other contaminants or foreign matter within the surrounding environment of the rapid response event into which the rapid response containerized edge data center unit 500 is deployed.

In some aspects, the rapid response containerized edge compute unit 500 can be based on ISO (International Organization for Standardization)-standardized intermodal shipping container dimensions of approximately 20 feet in exterior length, 9.5 feet in exterior height, and 8 feet in exterior width. In some aspects, the containerized housing can have exterior dimensions of 19 feet, 10 inches×9 feet, 6 inches×8 feet (L×W×H), although it is noted that various other housing dimensions and/or form factors may also be utilized for the housing of the rapid response containerized edge compute unit 500 without departing from the scope of the present disclosure. In some examples, the containerized housing of the rapid response containerized edge unit 500 can correspond to and/or conform to one or more of ISO 1496-1, ISO 1496-2, ISO 6346, and/or ISO 1161.

The rapid response containerized edge data center unit 500 can be designed for rapid deployment in various emergency situations and/or other rapid response events, as noted above. The rapid response containerized edge data center unit 500 can be configured as an emergency response unit with a modular form factor optimized for rapid deployments in order to provide critical functionalities such as electrical power, connectivity, communication, computation, and/or command and control capabilities, etc. The 20-foot containerized housing utilized in at least some embodiments for the rapid response containerized edge data center unit 500 can provide a compact and efficient footprint that is suitable for deployment and use in a wide variety of different disaster, emergency, and rapid response events and scenarios. The standardization of the 20-foot, steel construction maritime or shipping container can be associated with increased flexibility in transportation and deployment options, and can allow the rapid response containerized edge data center unit to be flexibly and versatilely configured for different emergency response situations or scenarios, as well as various other rapid response events and corresponding deployments.

For example, the modular, compact, and rugged form factor (e.g., 20-foot ISO-standardized steel shipping container, etc.) can be beneficial when moving the rapid response containerized edge data center unit 500 initially to an edge deployment site for a rapid response event, removing the rapid response containerized edge data center unit 5t00 from the edge deployment site after the rapid response event or need for the containerized edge data center unit 500 deployment has passed, and/or for repositioning operations to move the rapid response containerized edge data center unit 500 while the deployment and/or the rapid response event (or associated response) are still ongoing.

In some embodiments, the container size (e.g., housing size) of the rapid response containerized edge data center unit 500 can be increased or decreased depending on a deployment or transportation modality intended for use in transporting the containerized edge data center unit 500 to the location of a rapid response event (e.g., natural disaster, emergency, etc.). For example, the containerized housing may be sized to fit on a flatbed truck for transportation to the rapid response event deployment site, etc. In some cases, the containerized housing may be sized to fit on a trailer or other towable frame or towable apparatus that can be towed by various commercial and/or passenger vehicles, trucks, SUVs, etc., for improved and enhanced mobility and easy of deployment for the rapid response containerized edge data center unit 500. In one illustrative example, the rapid response containerized edge data center unit 500 can be transported and/or deployed to an edge location corresponding to a rapid response or emergency event using one or more multiple modes of transportation. For instance, intermodal transportation can be used to move the rapid response containerized edge compute unit 500 to a desired edge deployment site or location, based on the containerized housing using an ISO-standardized form factor compatible with intermodal shipping and transportation. Intermodal shipping (also referred to as intermodal freight transport) can involve transportation using multiple modes of transportation (e.g., rail/train, ship, aircraft, truck, etc.), without any additional handling of the freight itself when changing transportation modes. For instance, an intermodal shipping container can be offloaded from a cargo ship and placed directly onto an intermodal truck for delivery to a final destination, etc.

In some aspects, a containerized housing (e.g., containerized form factor, enclosure, etc.) of the rapid response containerized edge data center unit 500 can be implemented with a ruggedized and weatherproof design, to prevent the ingress of water or other fluids, dust or other particulate matter, etc. The rapid response containerized edge data center unit 500 can be configured to withstand extreme environmental conditions, including temperatures, pressures, humidity, radiation, electromagnetic (EM) and/or radio frequency (RF) interference, as well as adverse weather events such as rain, sleet, snow, high winds, hail, smog, fires, dust, etc.

In some aspects, the ruggedized containerized housing of the rapid response edge unit 500 can have an approximately 20-foot length and may be implemented as a modular and standardized shipping container form factor. The ruggedized housing design can ensure reliable connectivity, computing availability, storage availability and reliability, and power supply during rapid response events associated with natural disasters and/or man-made disasters, including but not limited to, wildfires, hurricanes, floods, earthquakes, dam breaks, landslides, avalanches, oil spills, and/or terrorist incidents, etc.

In some embodiments, the containerized housing used for the rapid response containerized edge data center unit 500 can be weatherproof and NEMA (National Electrical Manufacturers Association)-compliant, with a modular and compact containerized housing structure that enables easy transportation over unpaved roads, diverse off-road conditions, and delivery by various transportations means (e.g., such as by towed trailer, truck, SUV, helicopter, etc., without requiring or utilizing manual lifting, etc., as has been described previously above).

The rapid response containerized edge data center unit 500 can provide self-contained and self-sustaining functionalities to support emergency response, command and control, and various other functionalities, services, activities, etc., that may be provided by first responders, emergency responders, and/or local officials associated with the site of the emergency, disaster, or other rapid response event. For example, the rapid response containerized edge data center unit 500 can be configured to operate with or without a reliable connection to existing infrastructure (e.g., such as electrical infrastructure, communications infrastructure, computing, sensor/IoT data processing, cellular network infrastructure, internet infrastructure, etc.), as the existing infrastructure may either be unavailable (e.g., in remote edge locations), may be unreliable, may be damaged (e.g., damaged at least in part due to the disaster or other circumstances of the rapid response event for which the containerized edge data center unit 500 is deployed), and/or various combinations thereof. In some aspects, the rapid response containerized edge data center unit 500 can provide self-contained emergency response functionalities to the edge environment where the emergency, disaster, or other rapid response event has occurred (or is occurring). For example, the containerized edge data center unit 500 can provide critical functionalities such as power generation and/or power supply/distribution, connectivity, communications, command and control capabilities, etc., as will be described below with respect to the power control module 540, emergency response engine 560, compute engine 530, and/or communications engine 520 included within the rapid response containerized edge data center unit 500.

In some aspects, a power control module 540 (alternately referred to as a power control system, or power control sub-system of the rapid response containerized edge data center unit 500) can be used to control the input, output, generation, and/or storage of electrical energy associated with the rapid response containerized edge data center unit 500. For example, in some embodiments, the power control module 540 can include one or more energy generation sub-systems 542 (e.g., configured to generate electrical power or energy), one or more energy storage sub-systems 544 (e.g., configured to store electrical power or energy that is generated or received as input from the grid or other external source), one or more energy distribution interfaces 546, and one or more energy supply interfaces 548.

The energy generation sub-system(s) 542 can include one or more energy generators, configured to generate or otherwise provide electrical power to the rapid response containerized edge data center unit 500 without connection to an electrical grid or other external electrical power supply infrastructure. For example, the energy generation sub-system(s) 542 can include one or more diesel or gas generators (either included within the containerized housing volume of the rapid response edge unit 500, or deployed external to the containerized housing volume and connected via one or more external connections included in or provided by the energy supply interface 548). In some cases, the energy generation sub-system(s) 542 can include one or more solar panels or photovoltaic devices configured to generate electrical energy from incident sunlight upon the solar panels or photovoltaic device(s). Solar panels, solar panel arrays, and/or photovoltaic devices may be included in the energy generation sub-system 542 directly, and/or may be external to or otherwise not included within the rapid response edge unit 500 but may be coupled to the power control module 540 via one or more corresponding external connections included in the energy supply interface 548.

In one illustrative example, the power control module 540 can be include multiple and redundant power sources and/or corresponding connections thereto. For example, the rapid response containerized edge data center unit 500 can support emergency response for essential service and critical infrastructure providers, each of which may require (or strongly benefit from) a constant or uninterrupted supply of electrical power, particularly in natural disasters or other rapid response events where the existing electric service and existing electrical infrastructure has been damaged, destroyed, or otherwise disrupted. For example, the energy generation sub-system 542 may include multiple and redundant diesel generators (e.g., one or more primary diesel generators and one or more backup diesel generators), may include gas generators/turbines, may include multiple and redundant solar panel or photovoltaic arrays (e.g., one or more primary solar panel or photovoltaic arrays and one or more backup primary solar panel or photovoltaic arrays). In some embodiments, the energy generation sub-system 542 may include multiple and redundant power generation systems across different modalities or power generation functionalities. For example, the power control module 540 may include, within the energy generation sub-system 542, various combinations of primary or backup diesel generators and primary or backup solar panel/photovoltaic arrays, etc.

In some aspects, the rapid response containerized edge data center 500 can be configured for connection with one or more electrical power supplies that are local to the edge environment or rapid response event location into which the containerized edge data center unit 500 is deployed. For example, the power control module 540 can use the energy supply interface 548 to implement one or more external connections or couplings with a corresponding one or more external power supplies or power sources. In one illustrative example, the rapid response containerized edge data center 500 can be configured (e.g., via corresponding connectors or connections provided by the energy supply interface 548) for connection to the local electrical grid or other local edge electrical infrastructure available at the rapid response event edge deployment site. As noted previously, in at least some examples, the power control module 540 can include or otherwise implement one or more step-up/step-down transformers, and/or various other power conditioning or power cleaning equipment, for converting the local electrical delivery (e.g., the input electrical power voltage, phase, amperage, etc. received by the power control module 540) to a configured or desired voltage, power, phase, etc., that is suitable or desired for equipment at the local edge site or equipment that receives output power from the power control module 540. In some examples, the power control module 540 can include or implement one or more buck-boost transformers that can be used to reduce (e.g., buck) or raise (e.g., boost) the input voltage to a lower or higher output voltage, respectively. Connection to and use of external power supplies such as grid energy may be optional, such that the power control module 540 draws electrical power from the grid or other external source, using corresponding connections made with the energy supply interface 548, if such grid energy or other external supplies are available at the deployment location and during the rapid response event. In the case that grid energy or external energy sources are not available at the deployment location or during the rapid response event, the power control module 540 and the rapid response edge unit 500 can be configured to utilize self-contained and self-sustaining power supply systems provided by one or more (or both) of the energy generation sub-system 542 and/or the energy storage sub-system 544.

For instance, the power control module 540 may additionally include one or more energy storage sub-systems 544 that operate in combination with the energy generation sub-system 542 to provide electrical power to the rapid response containerized edge unit 500. In some aspects, the energy storage sub-system 544 and the energy generation sub-system 542 may be utilized as co-primary sources. In some aspects, the energy storage sub-system 544 can be configured as a backup or supplemental power supply to the primary power supply provided by the energy generation sub-system 542. In another example, the energy storage sub-system 544 can be configured as the primary power supply, and may be supplemented or backed up by the energy generation sub-system 542.

In some embodiments, the energy storage subsystem 544 can correspond to one or more onboard or backup power supplies included in, implemented by, or otherwise associated with the rapid response edge unit 500 and/or the power control module 540. In some aspects, the energy storage sub-system 544 can correspond to various generators and/or electrical generation systems or techniques (e.g., onboard or deployable solar panels, onboard or deployable electrical generators (e.g., diesel-powered combustion generators, etc.), wind turbines, etc.) included in the energy generation sub-system 542, and may store all of the generated electrical energy produced by the energy generation sub-system(s) 542, may store some/a portion of the generated electrical energy produced by the energy generation sub-system(s) 542, may store only an unused or excess portion of the generated electrical energy produced by the energy generation sub-system(s) 542, etc.

In one illustrative example, the energy storage sub-system(s) 544 can comprise or be implemented using one or more onboard or integrated energy storage systems of the rapid response containerized edge unit 500. For example, the energy storage sub-system(s) 544 can comprise one or more battery banks or battery arrays that can be used to store electrical power, where the input and output (e.g., charging and discharging) of electrical energy to and from the energy storage sub-system(s) 544 is controlled by the power control module 540. For example, the energy storage sub-system(s) 544 can be charged (e.g., receive an input of electrical power or energy) by one or more of the energy generation sub-system(s) 542, fed from the local grid (e.g., via the energy supply interface 548), and various combinations thereof.

The energy storage sub-system(s) 544 can be discharged (e.g., provide an output of electrical power or energy) to one or more of the energy distribution interface 546 and/or various other components or sub-components included within the rapid response containerized edge data center unit 500. For example, the energy storage sub-system(s) 544 can provide electrical energy or power to an electrical bus of the rapid response edge unit 500 (e.g., included in the energy distribution interface 546, etc.), where the electrical bus may be shared across the various sub-systems of the power control module 540 and/or wherein the various sub-systems of the power control module 540 may be provided with corresponding individual electrical buses (e.g., a first bus for the energy generation sub-system(s) 542, a second bus for the energy storage sub-system(s) 544, a third bus for the energy supply interface(s) 548, a fourth bus for the energy distribution interface(s) 546, etc.). In some embodiments, the energy storage sub-system 544 can comprise a battery bank or battery array that is integrated with or into the rapid response containerized edge data center unit 500, and/or can comprise a battery bank or battery array that is modularly combined with, attached to (e.g., via energy supply interface 548, etc.), or otherwise associated with the rapid response containerized edge data center unit 500.

The rapid response containerized edge data center unit 500 can utilize its power control module(s) 540 (e.g., including connection to local electric infrastructure via the energy supply interface 548, any or all onboard or backup electrical generation provided by energy generation subsystem 542 or the energy storage subsystem 544, respectively, any or all onboard or backup electrical storage provided by batteries onboard the edge data center unit 500, etc.) to both provide electrical power for running the operations of the rapid response containerized edge data center unit 500 itself, as well as to provide or distribute electrical power to one or more connected devices or apparatuses.

In one illustrative example, the energy distribution interface 546 can be used to distribute or provide electrical energy to local devices, users, etc., within the area of the rapid response event (e.g., local devices or users near the deployment of the rapid response containerized edge data center unit 500). In some aspects, the energy distribution interface 546 can additionally, or alternatively, be used to energize one or more electrical connections, outlets, hubs, temporary distribution or supply lines, etc., that are connected to the rapid response edge unit 500 via the energy distribution interface 546 and used to provide electrical power to the nearby environment of the deployment of the rapid response edge unit 500 into the rapid response event.

For example, the deployed rapid response containerized edge data center unit 500 can be configured to implement a power hub for local residents and/or emergency/first responders at the rapid response event, wherein the rapid response containerized edge data center unit 500 includes one or more power distribution interfaces 546 configured for use by the local residents, emergency and first responders, etc., to charge or otherwise power their various devices. In some embodiments, the power distribution interface 546 can be integral to the rapid response containerized edge data center unit 500, and/or can be modularly connected to an electrical bus or other electrical supply line fed by the energy generation subsystem 542 and/or energy storage subsystem 544 of the rapid response containerized edge data center unit 500.

In one illustrative example, the rapid response containerized edge data center unit 500 can be configured to provide a power source and communications hub for local residents and first/emergency responders within the local deployment environment for the rapid response event. For example, power source functionality can be implemented as described above, using the energy distribution interface 546 to provide power from the rapid response containerized edge data center unit 500 to the local area. In some aspects, the energy distribution interface 546 can be used to configured to rapid response edge unit 500 as a centralized power hub that can be used to provide device charging capabilities (e.g., a power source for responders and individuals to charge their various devices, including cell phones, walkie-talkies, and other connected devices such as cameras, satellite phones, emergency lighting, etc.).

The energy distribution interface 546 can additionally provide electrical power for recharging deployable devices, robotic devices, drones, unmanned devices or vehicles, autonomous and/or semi-autonomous devices or vehicles, ground vehicles, robots, and/or various other equipment utilized for the rapid response event or by emergency responders, etc. In some aspects, at least a portion of the deployable devices, robotic devices, drones, unmanned devices or vehicles, autonomous and/or semi-autonomous devices or vehicles, ground vehicles, robots, and/or various other equipment utilized for the rapid response event or by emergency responders, etc., can be associated with, included within, stowed by or within, deployed by or from, etc., the rapid response containerized edge data center unit 500 itself.

For example, at least a portion of the deployable devices, robotic devices, drones, unmanned devices or vehicles, autonomous and/or semi-autonomous devices or vehicles, ground vehicles, robots, and/or various other equipment utilized for the rapid response event or by emergency responders, etc. may be included in the deployable units 566 included in the emergency response engine 560 implemented by the rapid response edge unit 500.

As noted above, the deployable units 566 provided by or otherwise associated with the rapid response edge unit 500 can be electrically powered, and may be tethered to or recharged by the energy distribution interface 546 of the power control module 540. In some cases, some (or all) of electrically-powered and/or battery-powered devices or systems included in the peripheral devices 580 of the rapid response edge unit 500 may additionally be tethered to, recharged by, or otherwise electrically powered by the energy distribution interface 546 of the rapid response edge unit 500. For example, the peripheral devices 580 can include, but are not limited to, one or more of poor-weather and night lighting apparatuses and systems, flat-panel monitors for situational awareness, emergency notifications, data or analytics readouts, etc., among various other peripherals and devices that may be associated with, utilized by, or essential to providing disaster response (e.g., providing the response for the rapid response event). In some embodiments, the energy distribution interface 546 can include a plurality of weatherproof electrical ports or sockets, which can be used to provide (e.g., output) clean electrical power, from the energy generation subsystem 542, energy storage subsystem 544, and/or local electrical mains coupled to the energy supply interface 548 of the rapid response edge unit 500. The plurality of weatherproof electrical ports or sockets of the energy distribution interface 546 can provide output electrical power at varying voltages and current ratings (e.g., various different combinations of output voltage and output current, or ranges thereof).

The rapid response containerized edge data center unit 500 can include resources for low-latency connectivity and high-performance computing (e.g., including support for ML and/or AI workloads inferencing locally at the edge deployment site corresponding to the rapid response event). In some aspects, the rapid response containerized edge data center unit 500 can include a compute engine 530 that is the same as or similar to the HPC engine 434 and/or local database 436 of the edge compute unit 430 described above with respect to FIG. 4. In some aspects, the HPC engine 434 can include a plurality of accelerated computing units configured to provide high-performance and/or accelerated computing for various edge workloads (e.g., including ML/AI workloads and various other workloads that may be associated with one or more ML/AI applications inferencing locally and in real-time on the rapid response containerized edge data center unit 500). For example, the HPC engine 434 can include one or more (or a plurality of) accelerated computing units such as GPUs, tensor processing units (TPUs), neural processing units (NPUs), application-specific integrated circuits (ASICs), field-programmable gate arrays (FPGAs), multi-core CPUs, etc.

For instance, the compute engine 530 can include a first compute instance 530-1, a second compute instance 530-2, . . . , and an Nth compute instance 530-N. In some aspects, the compute instances 530-1, . . . , 530-N can be used to implement one or more (or all) of the operations described above with respect to the edge compute unit 430 of FIG. 4. For instance, the compute instances 530-1, . . . , 530-N implemented by the rapid response containerized edge data center unit 500 of FIG. 5 can implement one or more (or all) of the ML/AI model inference instances 435-1, . . . ,435-N of FIG. 4, the ML/AI model retraining instances 433-1, . . . , 433-K of FIG. 4, the ML/AI model finetuning instances 434-1, . . . , 434-M of FIG. 4, etc.

In some aspects, the compute engine 530 can be implemented using one or more server racks provisioned with the corresponding computational hardware components. For example, FIG. 6A is a diagram illustrating a first configuration 610-1 of a rapid response containerized edge data center unit including three compute racks, in accordance with some examples; FIG. 6B is a diagram illustrating a second configuration 610-2 of a rapid response containerized edge data center unit including two compute racks and a command/control station, in accordance with some examples; and FIG. 6C is a diagram illustrating a third configuration 610-3 of a rapid response containerized edge data center unit including a compute rack and two command/control stations, in accordance with some examples. In some aspects, the rapid response containerized edge data center unit configuration 610-1 of FIG. 6A, the rapid response containerized edge data center unit configuration 610-2 of FIG. 6B, and/or the rapid response containerized edge data center unit configuration 610-3 of FIG. 6C can be associated with or otherwise correspond to a rapid response containerized edge data center unit that is the same as or similar to one or more (or both) of the edge compute unit (e.g., containerized edge data center unit) 430 described previously above with respect to FIG. 4, and/or to the rapid response containerized edge data center unit 500 described previously above with respect to FIG. 5.

As noted above, in some aspects, the compute engine 530 can be implemented using one or more server racks provisioned with the corresponding computational hardware components. For example, the compute engine 530 can be implemented by a one-rack configuration (e.g., such as the one-rack configuration 610-3 of FIG. 6C), can be implemented by a two-rack configuration (e.g., such as the two-rack configuration 610-2 of FIG. 6B, can be implemented by a three-rack configuration (e.g., such as the three-rack configuration 610-1 of FIG. 6A, etc.).

In some embodiments, the rapid response containerized edge data center unit 500 can include one or multiple compute engines 530, and each respective one of the compute engines 530 can correspond to a respective server rack. For example, the one-rack configuration 610-3 of FIG. 6C can be used to implement one instance of the compute engine 530 with the respective compute notes 530-1, . . . , 530-N. The two-rack configuration 610-2 of FIG. 6B can be used to implement two instances of the compute engine 530, where each instance (and each rack) implements a respective/corresponding set of the compute nodes 530-1, . . . , 530-N. In another example, the three-rack configuration 610-1 of FIG. 6A can be used to implement three instances of the compute engine 530, where each instance (and each rack) implements a respective/corresponding set of the compute nodes 530-1, . . . , 530-N.

In some examples, the various compute nodes 530-1, . . . , 530-N associated with a particular compute engine 530 instance may all be implemented on the same server rack of the rapid response containerized edge data center unit 500. In other examples, the various compute nodes 530-1, . . . , 530-N of a particular compute engine 530 instance can be striped across multiple different server racks (e.g., when available) of the rapid response containerized edge data center unit 500. In some cases, each compute node of the plurality of compute nodes 530-1, . . . , 530-N associated with a given instance of the compute engine 530 can be associated with and implemented by or on a different server rack included within the rapid response containerized edge data center unit 500.

The compute engine(s) 530 included in the rapid response containerized edge data center unit 500 can be used to provide and/or implement low-latency communication and computing resources that are critical for disaster management and monitoring (e.g., associated with providing the response to the rapid response event, by the edge data center unit 500). The compute engine(s) 530 can be used to provide high-performance and low-latency local (e.g., at the edge deployment site) processing of streaming information, including audio, video, and/or sensor data streamed to the rapid response edge data center unit 500 by various drones, robots, ground vehicles, etc., included within the deployable units 566 and/or peripheral devices 580 associated with the rapid response containerized edge data center unit 500. In some aspects, the rapid response, containerized edge data center unit 500 can be deployed to enable low-latency applications of high-performance computing at one or multiple edge locations (e.g., the location of a disaster event, emergency event, or other event or occurrence associated with a deployment of the rapid response containerized edge data center unit 500). The rapid response containerized edge data center unit 500 can additionally be used to enable various ML and/or AI workloads to be deployed at the remote edge, as well as to enable data sovereignty at the remote edge. Each containerized edge data center unit can be configured as a mobile, fully-integrated, enterprise-grade high-performance compute solution.

In some embodiments, the rapid response containerized edge data center unit 500 can provide redundant and seamless integrated connectivity, power, and compute application hosting capabilities, locally at the edge deployment to the rapid response event. The deployment of the rapid response containerized edge data center unit 500 can ensure that essential services remain accessible, including in challenging or hostile environments, conditions, emergency situations, etc., to first/emergency responders and/or to the local population. The rapid response containerized edge data center unit 500 can support and provide multiple communication modalities, including cellular (e.g., 3G, 4G/LTE, 5G/NR, etc.) connectivity to both public and/or private cellular networks; satellite connectivity to public, private, first-party, third-party, etc., satellite communication network constellations; wired connectivity to existing internet backhaul or backbone infrastructure, where available; etc. The rapid response containerized edge data center unit 500 can additionally, or alternatively, support and provide communications using one or more of a Long-Range Wide Area Network (LoRaWAN), a wireless Highway Addressable Remote Transducer (WirelessHART), narrowband internet-of-things (NB-IoT), Zigbee, Z-Wave, etc.

For example, a communications engine 520 can include one or more local communications sub-systems 522 and one or more remote communications sub-systems 526. In some aspects, the rapid response containerized edge data center unit 500 may additionally include a local/private network node 510, such as a cellular base station, eNB (e.g., for providing a private 4G/LTE cellular communications network around the rapid response edge unit 500), gNB (e.g., for providing a private 5G/NR cellular communications network around the rapid response edge unit 500), etc. In some examples, the rapid response containerized edge data center unit 500 can include a network node 510 and/or a communications sub-system 522 configured to provide one or more (or all) of a Long-Range Wide Area Network (LoRaWAN), communications via WirelessHART, communications via NB-IoT, communications via Zigbee, communications via Z-Wave, communications via satellite networks and/or satellite relay, etc.

In some embodiments, the rapid response containerized edge data center unit 500, and in particular, the communications engine 520 thereof, can provide (and, in some embodiments) combine multiple remote communication links or modalities to provide increased throughput or bandwidth, as well as to provide improved redundancy and resistance to failures or network outage events. In one illustrative example, the rapid response containerized edge data center unit 500 can be configured to provide one or more local communication networks within the vicinity or surrounding environment of the rapid response containerized edge data center unit 500 as deployed to the edge location within or corresponding to the rapid response event. The one or more local communication networks can be implemented, configured, controlled, managed, etc., by the local communications sub-system(s) or nodes 522 included in the onboard communications engine 520 of the rapid response edge unit 500.

For example, the rapid response containerized edge data center unit 500 can provide one or more wired access networks, wireless local area network (WLAN) networks (e.g., based on IEEE 802.11 communication standards, etc.), etc., configured to support local communications within or associated with the physical location of rapid response event and the deployed rapid response edge compute unit 500. In some aspects, the local communications sub-system(s) 522 can include one or more corresponding wireless transceivers for providing local LTE/4G/5G/NR cellular connectivity, with the cellular range of the local communication network (e.g., local private cellular network) extending for multiple miles along a radius centered about the deployment location of the rapid response edge unit 500 and the communications engine 520 thereof (e.g., the local communications sub-system 522 and/or local/private network node 510 included in and implemented by the rapid response edge unit 500). In some embodiments, the local communications sub-system(s) 522 can include one or more corresponding wireless transceivers for providing local LoRaWAN connectivity, WirelessHART connectivity, NB-IoT connectivity, Zigbee connectivity, Z-Wave connectivity, satellite communications connectivity, etc.

In some cases, the local communications subsystem 522 can be configured to provide a local wireless network comprising a WiFi network local to the deployment site of the rapid response edge unit 500 at the rapid response event, with a WiFi communications range of up to 1,000 feet (or greater). The remote communications subsystem(s) 526 of the communications engine 520 can include one or more satellite transceivers configured to provide internet/cloud connectivity to the local edge site of the rapid response event/to the rapid response edge unit 500, with the remote communications subsystem 526 and constituent satellite transceivers thereof providing one or multiple high-speed and low-latency satellite connectivity links for cloud access (e.g., as will be described in greater detail below).

The communications engine 520 can be configured to support various mesh networks and mesh networking techniques, as well as configured to support various different routers, routing techniques, protocols, etc., and relaying capabilities to inform local communities of emergency information (e.g., including emergency information from the emergency notification engine 57y2, command and control engine 574, and/or communications hub/relay engine 576 included in the emergency response engine 560 of the rapid response edge unit 500, etc.).

In some aspects, the rapid response edge compute unit 500 can provide communications hub or communications relay functionality, enabling communications between the various devices used by local residents and first/emergency responders at the location of the rapid response event (e.g., intra-edge communications, facilitated or mediated by the rapid response edge compute unit 500, the local communications subsystem(s) 522 and/or the local/private network node 510, and the corresponding one or more WLANs implemented thereby). For example, communications hub or relay functionalities can be implemented by the communications hub/relay engine 576 included in the emergency response engine 560, where the communications hub/relay engine 576 can provide a communications hub/relay for communications on the local network(s) provided by the local communications subsystem 522, can provide a communications hub/relay for communications on the remote communications subsystem 526, and/or can provide a communications hub/relay for communications between or across both the local communications subsystem 522 and the remote communications subsystem 526.

The rapid response containerized edge data center unit 500 can additionally provide communications from the local edge/location of the rapid response event to the wider internet or other remote locations (e.g., inter-edge communications, facilitated or mediated by the rapid response edge compute unit 500 and the remote communications sub-system(s) 526 of the communications engine 520 acting as a relay or communications hub bridging between the WLANs at the rapid response event and one or more remote communication networks connected to the rapid response edge compute unit 500).

In one illustrative example, the remote communications subsystem 526 of the communications engine 520 can include one or multiple satellite transceivers, configured to provide bidirectional communications with a satellite internet constellation or other satellite-based communications system. An edge deployment site (e.g., an edge location of the rapid response event for which the rapid response containerized edge data center unit 500 is deployed) can include one or more user terminals (e.g., user devices, computing devices, edge, devices, UEs, edge assets, automation controls, etc.) that are included within, integrated in, or otherwise associated with the rapid response edge unit 500, as well as one or more external devices that are associated with local residents or first/emergency responders but are not included in the rapid response containerized edge data center unit 500 itself.

For instance, the user terminals/devices may be the same as or similar to one or more of the UE 104 of FIG. 1, the UE 230 of FIGS. 2A and 2B; the edge data center apparatus 300a of FIG. 3A and/or 300b of FIG. 3B; the edge compute unit 430 and/or the edge assets 410 of FIG. 4;the rapid response containerized edge data center unit 500, communications engine 520, local communications subsystem 522, remote communications subsystem 526, local/private network node 510, etc., of FIG. 5; etc.

The user terminals can be associated with a local network, which can be a local edge network provided at the same edge deployment site or location as the user terminals. For instance, the local edge network can be a local network provided by the local/private network node 510 and/or local communications subsystem 522 of the rapid response containerized edge data center unit 500 of FIG. 5. In some aspects, the local edge network can be the same as or similar to the local network 420 of FIG. 4, associated with and created by the edge compute unit 430 of FIG. 4.

In some examples, the local edge network can be associated with (e.g., connected to, relayed to, routed or bridged with, etc.) satellite internet connectivity. For instance, the local edge network can be coupled to a satellite router included in the remote communications subsystem 526 of FIG. 5 and/or satellite user terminal included in the remote communications subsystem 526, where the satellite router and/or satellite user terminal are configured to provide communications and/or connectivity with a satellite internet constellation. In some embodiments, the satellite internet constellation can be the same as or similar to one or more of the satellite internet constellations described with respect to FIGS. 2A and/or 2B.

In one illustrative example, the communications engine 520 of FIG. 5 can be the same as or similar to, or may be used to implement, the communications engine 720 of FIG. 7. In particular, FIG. 7 is a diagram 700 illustrating an example of a communications engine 720 that can be used to provide bonded satellite communication uplink and/or downlink using a plurality of satellite constellation transceivers, in accordance with some examples.

In one illustrative example, the communications engine 720 can be included in a rapid response containerized edge data center unit that is the same as or similar to one or more of the edge compute unit 430 of FIG. 4, the rapid response containerized edge data center unit 500 of FIG. 5, the rapid response containerized edge data center unit configuration 610-1 of FIG. 6A, the rapid response containerized edge data center unit configuration 610-2 of FIG. 6B, and/or the rapid response containerized edge data center unit configuration 610-3 of FIG. 6C. In some aspects, the communications engine 720 of FIG. 7 can be the same as or similar to the communications engine 520 included in the rapid response containerized edge data center unit 500 of FIG. 5. In some embodiments, the communications engine 720 of FIG. 7 can be the same as or similar to the remote communications engine 526 included in the communications engine 520 of the rapid response containerized edge data center unit 500 of FIG. 5.

In some aspects, the communications engine 720 can include a plurality of satellite transceivers 702-1, 702-2, . . . , 702-N that are configured to communicate with one or more satellite internet constellations 712. In some embodiments, the satellite internet constellation(s) 712 of FIG. 7 can be the same as or similar to one or more of the satellite internet constellations described above with respect to FIGS. 2A and 2B. In some examples, each satellite transceiver 702-1, 702-2,. . . , 702-N may be configured to provide a respective uplink and downlink to the same satellite internet constellation 712. Each satellite transceiver 702-1, 702-2, . . . , 702-N may communicate with the same satellite of the satellite internet constellation 712, and/or may communicate with different satellites of the satellite internet constellation 712. The satellite transceivers 702-1, 702-2,. . . , 702-N may be the same as or similar to one another, or may be different from one another. In some embodiments, at least a first portion of the plurality of satellite transceivers 702-1, 702-2, . . . ,702-N can communicate with a first satellite internet constellation 712, and at least a second portion of the plurality of satellite transceivers 702-1, 702-2, . . . , 702-N can communicate with a second satellite internet constellation 712 that is different from the first satellite internet constellation.

The satellite internet constellation 712 may be used, in at least some cases, to provide a portion of the internet backhaul links between the local edge network at the rapid response event deployment site of the edge unit 500, and a remote network (e.g., the internet, an enterprise intranet or network, etc.). For instance, communications transmitted and/or received via satellite internet constellation 712 and the satellite transceivers 702-1, 702-2, . . . , 702-N (e.g., where each satellite transceiver includes or is associated with a satellite user terminal and/or a satellite router) can be associated with one or more links included in the set of internet backhaul links 440 shown in FIG. 4. As illustrated in FIG. 7, each respective one of the plurality of satellite transceivers 702-1, 702-2,. . . , 702-N can include a respective uplink (UL) and downlink (DL) to and from the satellite internet constellation 712, and a respective UL and DL to the communications engine 720 (e.g., coupled to the satellite link bonding engine 725 of the communications engine 720, described in greater detail below).

As used herein, satellite internet constellation 712 edge connectivity hardware can refer to a satellite user terminal, a satellite router 845, or both. The satellite internet constellation 712 edge connectivity hardware can be included in (e.g., deployed to the edge site by) the rapid response containerized edge data center unit 500 of FIG. 5, and more particularly, may be included in the remote communications subsystem 526. The satellite internet constellation 712 edge connectivity hardware may include one or more (or a plurality of) satellite transceivers (also referred to as satellite dishes) for implementing the physical transmission and reception of wireless communications to and from, respectively, various satellites of the satellite internet constellation 712 (e.g., the plurality of satellite transceivers 702-1, 702-2, . . . , 702-N).

The plurality of satellite transceivers 702-1, 702-2, . . . , 702-N can provide bidirectional communications to the individual satellites (e.g., overhead or within range/line-of-sight of the edge deployment location of the rapid response containerized edge data center unit 500 that includes or implements the communications engine 720, etc.) of the satellite internet constellation 712. To implement a satellite transceiver/satellite dish for communications with the satellite internet constellation 712, the satellite transceivers (e.g., 702-1, 702-2, . . . , 702-N) can, for example, include a phased-array antenna that includes multiple antenna elements for establishing a two-way (bi-directional) communication link with satellites of the satellite internet constellation 712. In addition to the phased-array antenna, the satellite transceivers (e.g., 702-1, 702-2, . . . , 702-N) may include control circuity or components for performing electronic beamforming to steer the antenna beam onto the overhead satellite(s) of the satellite internet constellation 712, to enable improved signal quality, automatic alignment with the overhead satellites of the satellite internet constellation 712, etc.

In some cases, the satellite transceivers (e.g., 702-1, 702-2, . . . , 702-N) can include a phased-array antenna and beamforming/alignment control module(s) for communications over the communication links shown in FIG. 7 between the respective satellite transceivers 702-1, 702-2, . . . ,702-N and the satellite internet constellation 712. The satellite transceivers 702-1, 702-2, . . . ,702-N can each further include an integrated modem, which modulates the signals sent (e.g., from the communications engine 720 of the rapid response containerized edge data center unit 500) to the satellite internet constellation 712 and demodulates the signals received from the satellite internet constellation 712.

Each satellite transceiver 702-1, 702-2, . . . , 702-N can be associated with (e.g., communicatively coupled) with a corresponding satellite router that is provided at the local edge deployment site (e.g., by or within the rapid response edge unit 500, the communications engine 520, the remote communications subsystem 526, the communications engine 720, etc.). The satellite router can be used to couple the digital data connectivity from the input/output of the integrated modem of the satellite transceiver (e.g., 702-1, 702-2, . . . , 702-N) to the satellite link bonding engine 725, which can be configured to aggregate the individual uplink associated with each one of the satellite transceivers 702-1, 702-2, . . . , 702-N into a bonded (e.g., aggregated) uplink 709 that combines that bandwidth and communications capacity of the plurality of individual uplinks from the plurality of satellite transceivers into a single, logical link implemented by, available at, provided by, etc., the communications engine 720 and the satellite link bonding engine 725.

Similarly, the satellite link bonding engine 725 can be configured to aggregate the individual downlink associated with each one of the satellite transceivers 702-1, 702-2, . . . , 702-N into a bonded (e.g., aggregated) downlink 707 that combines the bandwidth and communications capacity of the plurality of individual downlinks from the plurality of satellite transceivers into a single, logical link implemented by, available at, provided by, etc., the communications engine 720 and the satellite link bonding engine 725.

The link bonding provided by the satellite link bonding engine 725 can provide redundancy and resiliency for the remote communications provided by the plurality of satellite transceivers 702-1, 702-2, . . . , 702-N and the satellite internet constellation 712. By bonding multiple satellite transceivers together (e.g., using the satellite link bonding engine 725), the communications engine 720 can implement reliable, high-throughput connectivity, improved quality-of-service (QOS), and improved and/or increased continuous availability of remote communications to the cloud/the satellite internet constellation 712. In some aspects, the communications engine 720 can couple the bonded downlink 707 and bonded uplink 709 associated with the plurality of satellite transceivers 702-1, 702-2, . . . , 702-N and the satellite internet constellation 712 to the local communications network subsystem 522 of FIG. 5, such that the bonded satellite uplink and downlink 709, 707 (respectively) can be connected to and used to implement various mesh network configurations to extend local network coverage at the rapid response event deployment location of the edge unit 500 (e.g., various mesh network configurations to extend coverage for devices, sensors, cameras, robots, etc., included in the deployable units 566 of the rapid response containerized edge data center unit 500 of FIG. 5).

Networking solutions implemented or otherwise provided by the rapid response containerized edge data center unit 500 (and/or the communications engine 520 and/or communications engine 720 thereof) can, in at least some embodiments, operate independently and/or can integrate back into a wider network (e.g., a remote network such as that provided by the satellite internet constellation 712, or connected to via the remote communications network subsystem 526, etc.), thereby enabling real-time data sharing to and from the rapid response containerized edge data center unit 500 at the deployment site for the rapid response event, including when existing networks are down.

Notably, the high resiliency and high redundancy communications provided by the rapid response containerized edge data center unit 500 can be configured to enable real-time data sharing beyond command and forward operations teams, when operating beyond the reach of existing networks during a rapid response event deployment. In some aspects, the high resiliency and high redundancy communications provided by the rapid response containerized edge data center unit 500 can be configured and used to provide a private, secure mesh network at the local deployment site for the rapid response event, with the ability to operate independently when one or more existing networks are down (e.g., due to the natural disaster, emergency, or other occurrence underlying the rapid response event that triggered the deployment of the rapid response containerized edge data center unit 500, etc.).

In addition to communications redundancy provided by the communications engine 520/720 and/or the plurality of satellite transceivers 702-1, 702-2, . . . , 702-N (and the corresponding satellite link bonding engine 725), the rapid response containerized edge data center unit 500 can additionally implement redundancy across other dimensions or aspects of the edge system. For example, high resiliency can be configured by building redundancy into aspects such as storage (e.g., storage striped across multiple drives of the rapid response edge unit 500); multiple compute servers and/or server racks associated with implementing the compute engine(s) 530 and constituent compute nodes 530-1, 530-2, . . . , 530-N; disparate backhaul connectivity links (e.g., provided by the remote communications subsystem 526, the plurality of satellite transceivers of FIG. 7, the communications engine 520 of FIG. 5, the communications engine 720 of FIG. 7, etc.). In some aspects, disparate and redundant internet backhaul connectivity can be implemented by and for the rapid response containerized edge data center unit 500 based on the remote communications subsystem 526 including one or more broadband links, one or more satellite internet constellation links, etc. As noted previously, the satellite internet constellation links can be used to communicatively couple the rapid response containerized edge data center unit 500 to one or multiple different satellite internet constellation providers (e.g., one or more multiple different satellite internet constellations 712). The disparate and redundant backhaul connectivity associated with and implemented by the rapid response containerized edge data center unit 500 can additionally, or alternatively, include one or more of local WiFi connectivity, local (e.g., private) cellular network connectivity over 4G/LTE, 5G/NR, etc., local private mesh networks, local multi-WAN networks and/or local multi-WAN routers included in or otherwise implemented by the rapid response edge unit 500 and/or local communications networking subsystem(s) 522, Bluetooth networks and/or communication links, etc.

Returning to the discussion of the example architecture of the rapid response containerized edge data center unit 500 of FIG. 5, an emergency response engine 560 can include one or more local sensors and/or devices 562, which can be used to collect sensor data that feeds one or more workloads, applications, ML or AI inference workloads or processes, etc., running on the compute engine 530. In some embodiments, the local sensors/devices 562 can be the same as or similar to the local site cameras 414, the environmental sensors 412, and/or other edge assets 410 of FIG. 4. The local sensors/devices 562 can be included in or integrated with the containerized edge data center unit 500, can be deployed by or associated with the rapid response containerized edge data center unit 500, can be remote or external to but associated with the rapid response containerized edge data center unit 500, etc. In some aspects, remote sensors/devices 564 can be deployed by the rapid response containerized edge data center unit 500, and/or can be communicatively coupled to the rapid response containerized edge data center unit 500 over one or more local networks provided by the local communications networking subsystems 522 of the rapid response edge unit 500. Similarly, the autonomous robots 416 and/or other edge assets 410 of FIG. 4 can be included in or otherwise associated with the deployable units 566 of the rapid response containerized edge data center unit 500 of FIG. 5.

The emergency response engine 560 can be used to implement various command and control functionalities and/or capabilities by or for the rapid response containerized edge data center unit 500. In some aspects, the emergency response engine 560 can be the same as, or similar to, the command and control station shown in the example configuration 610-2 of FIG. 6B. In some examples, the emergency response engine 560 can be the same as, or similar to, the first command and control station and/or the second command and control station both shown in the example configuration 610-3 of FIG. 6C. In some embodiments, the command and control stations shown in the example configurations 610-2, 610-3 of FIGS. 6B and 6C, respectively, can include or can comprise a desk station or other seating system for one or more emergency/first responders who are users of the rapid response containerized edge data center unit 500 (e.g., a desk station or seating system for viewing one or more monitors or displays, interacting with peripheral devices 580, etc.). For example, the rapid response containerized edge data center unit 500 can house or include a command-and-control station (e.g., such as the command and control station(s) of FIGS. 6B and 6C, etc.) configured to provide situational awareness and real-time updates from first responders and emergency personnel who are engaged in the rapid response event and associated with the rapid response containerized edge data center unit 500. The one or more command and control stations of the rapid response edge unit 500 can be associated with the configuration of the rapid response edge unit 500 as a centralized location for power, communication, connectivity, compute, command, and control functionalities for driving the rapid response to the rapid response event. The command and control stations of the rapid response edge unit 500 can be used by users (e.g., first responders, emergency responders, etc.) to interface and interact with screens, consoles, seating, etc., for operational planning, monitoring, and/or coordination tasks, etc., that utilize one or more components and/or functionalities of the rapid response containerized edge data center unit 500.

For example, the command and control stations of FIGS. 6B and 6C, the command and control engine 574 of FIG. 5, and/or various other components of the emergency response engine 560 or rapid response containerized edge data center unit 500 of FIG. 5 can be used by emergency and/or first responders to coordinate, implement, oversee, etc., emergency and disaster response efforts for the rapid response event into which the rapid response edge unit 500 is deployed. In one illustrative example, the command and control stations of FIGS. 6B and 6C, the command and control engine 574 of FIG. 5, and/or various other components of the emergency response engine 560 or rapid response containerized edge data center unit 500 of FIG. 5 can be used to interact with, configure, and otherwise utilize one or more emergency and disaster response applications running at the low-latency and high-performance edge compute engine 530 of FIG. 5.

For example, the systems and techniques can provide a platform to run, at the local edge environment corresponding to the rapid response event deployment, various emergency response applications with very low latency (e.g., without communicating back to the cloud and/or other remote computing infrastructure, servers, etc.). The various emergency response applications can run on the one or more compute engines 530 and/or constituent compute nodes 530-1, 530-2, . . . ,530-N thereof, shown in FIG. 5, and/or can run on the compute/server racks shown in the various rapid response edge unit configurations 610-1, 610-2, 610-3 of FIGS. 6A-6C (respectively).

The emergency response applications and rapid response event/disaster response tools implemented on or by the compute engine 530 can include algorithmic and programmatic workloads, AI/ML workloads, and various combinations thereof. The emergency response applications can be implemented at least in part based on data, information, and other inputs received at the rapid response containerized edge data center unit 500 using local area connectivity (e.g., local communications network subsystem 522, local/private network node 510, etc.), for example from sensors and devices that are connected and relaying data to the rapid response edge unit 500 and one or more emergency response applications running at the rapid response edge unit 500. In some aspects, the local sensors/devices 562, remote sensors/devices 564, deployable units 566, etc., can be connected to the local area network(s) of the rapid response edge unit 500, and may stream or otherwise relay sensor data or other information as inputs to various ones of the one or more emergency response applications implemented by the compute engine 530 and emergency response engine 560 (e.g., command and control engine 574) included in the rapid response containerized edge data center unit 500.

In some embodiments, the input sensor data to the rapid response applications and tools implemented by the emergency response engine 560 and/or the compute engine 530 can be relayed via the communications hub and relay engine 576 included in the emergency response engine 560. In some aspects, the rapid response edge unit 500 can be configured to host various communication and coordination applications, including but not limited to messaging applications for real-time communication among responders and agencies active at the rapid response event deployment. The rapid response edge unit 500 may additionally be configured to host incident management applications for coordinating response efforts, tracking progress, etc., with the corresponding information of the hosted applications being provided to users via the command and control engine 574, the emergency notification engine 572, the communications hub and relay engine 576, one or more displays or user interface elements included in the peripheral devices 580, etc.

The rapid response applications and tools associated with and/or provide by the rapid response edge unit 500 can additionally include one or more collaboration applications that may be used for sharing information, documents, files, data, resources, etc., among the responders and/or agencies on scene, as well as to the local residents affected by or nearby to the disaster or rapid response event that initially triggered the deployment of the rapid response edge unit 500. In some aspects, the emergency response engine 560 can be configured to provide access to various social media platforms to individuals on scene at the rapid response event, such that the access to the various social media platforms can be used to disseminate and/or seek information about those impacted by the disaster, etc. For example, the emergency response engine 560 can implement check in or personal status aggregation and dissemination to centrally track and manage the individual information, needs, etc., for each individual in the local area of the rapid response event, etc. In some cases, the check-in or personal status aggregation can be implemented by the emergency notification engine 572, by the command and control engine 574, by the communications hub and relay engine 576, and/or various combinations thereof, etc.

The rapid response applications and tools provided by the rapid response containerized edge data center unit 500 may further include the hosting of one or more geographic information systems (GIS) applications, base maps or base mapping applications or databases (e.g., including vector and/or satellite imagery, etc.) for mapping incident locations, emergency response resources, hazards, etc. The GIS and/or mapping applications and tools included in the rapid response applications and tools of the emergency response engine 560 and/or implemented by the compute engine 530 may further include various navigation tools or applications that can be used for functionalities such as route planning, determining and sharing evacuation routes and related information, locating nearby resources and facilities, etc.

The rapid response applications and tools provided by the rapid response containerized edge data center unit 500 may further include the hosting of one or more resource management applications, which can be used by responders, agencies, and/or local residents affected by the rapid response event to access or otherwise utilize one or more inventory management systems for tracking and managing equipment, supplies, personnel, etc. In some cases, the one or more resource management applications can include resource allocation tools for deploying resources based on needs and priorities.

In some embodiments, the rapid response applications and tools provided by the rapid response containerized edge data center unit 500 may further include alerting applications for disseminating emergency alerts, warning, and/or instructions to the public and/or to the emergency response personnel and agencies on scene or otherwise associated with the response to the rapid response event. In one illustrative example, the alerting applications or functionality can be implemented using the emergency notification engine 572 of the rapid response containerized edge data center unit 500. The emergency notification engine 572 can be configured to disseminate emergency alerts, notifications, and other related information using the local networks created by the rapid response edge unit 500 (e.g., a local private cellular network created by the local/private network node 510, a mesh network or other WLAN implemented by the local communications network subsystem 522, etc.). The emergency notification engine 572 and/or other alerting and messaging tools included in the rapid response applications and tools implemented by the rapid response containerized edge data center unit 500 may additionally include one or more non-emergency notification applications, which may be used to inform responders, stakeholders, and/or affected populations about developments, updates, etc., relating to the ongoing response to the rapid response event into which the containerized edge data center unit 500 is deployed.

In some embodiments, the rapid response applications and tools provided by the rapid response containerized edge data center unit 500 may further include one or more survey and assessment tools for conducting damage assessments and evaluating the impact of disasters (e.g., or other rapid response events into which the containerized edge data center unit 500 is deployed). In some aspects, the survey and assessment tools provided by the rapid response edge unit 500 and/or emergency response engine 560 thereof may be extended to include one or more recovery planning and management systems for coordinating long-term recovery efforts and rebuilding processes responsive to the natural disaster, emergency, or other rapid response event.

In another example, the rapid response applications and tools provided by the rapid response containerized edge data center unit 500 may further include one or more volunteer management platforms for recruiting, organizing, and coordinating volunteers during emergencies. In another example, the rapid response applications and tools provided by the rapid response containerized edge data center unit 500 may further include one or more donation management systems for collecting, tracking, and distributing donations and aid resources.

In some embodiments, the local sensors/devices 562, the remote sensors/devices 564, the deployable units 566, and/or various other components include in or associated with the rapid response containerized edge data center unit 500 can include or otherwise be used to implement one or more internet-of-things (IoT) sensor networks for real-time situational awareness of the rapid response event. For example, the emergency response engine 560 and/or command and control engine 574 thereof can be configured to provide various dashboard and visualization tools for monitoring and analyzing real-time data (e.g., from the one or more IoT sensor networks associated with or implemented by the rapid response edge unit 500) on incidents, weather, and other relevant factors that impact emergency response and efforts relating to the rapid response event causing the deployment of the rapid response edge unit 500. In some embodiments, the dashboards and tools can be configured to show updates and progress in real time without being dependent on connectivity to a remote cloud or remote infrastructure (e.g., the dashboard tools and display of updates or progress thereon can be implemented entirely locally, at the edge/location of the rapid response event, using the compute engine 530 and rapid response containerized edge data center unit 500). In some embodiments, the one or more IoT sensor networks included in, deployed by, or otherwise associated with and used by the rapid response containerized edge data center unit 500 can include IoT and/or sensor networks and monitoring systems for collecting data on environmental conditions, air quality, infrastructure integrity, etc.

In some aspects, the emergency response engine 560 and command and control engine 574 can be used to provide automatic (e.g., autonomous), semi-automated (e.g., semi-autonomous), and/or manual connectivity and control of the various deployable units 566 or other deployable units on scene for the rapid response event and associated with (e.g., connected to, registered with, etc.) the rapid response edge unit 500. For example, the emergency response engine 560 and command and control engine 574 can be used to provide connectivity and control of drones, UAVs, uncrewed ground vehicles (UGVs), autonomous underwater vehicles (AUVs), unmanned surface vehicles (USVs), articulated arms, cobots, embedded robots or robotic units, etc., for tasks such as real-time mapping and inspection of large geospatial areas. As noted previously, one or more (or all) of the drones, UAVs, UGVs, AUVs, USVs, embedded robots or robotic units, etc., can be included in the deployable units 566 of the emergency response engine 560 of the rapid response containerized edge data center unit 500.

In one illustrative example, the rapid response containerized edge data center unit 500 can be used to implement voice-enabled conversational assistance and/or other applications, tools, hardware, devices, systems, etc., for hands-free operations by emergency or first responders, agencies, etc., that are on scene to provide response efforts for the ongoing rapid response event into which the containerized edge data center unit 500 has been deployed. For example, the compute engine 530 can run local ML or AI models for voice-enabled conversational assistance with the responders, enabling voice-to-text and/or text-to-voice interfaces between the responders in the field and the ML/AI models or other resources running on the compute engine 530 or otherwise implemented by the rapid response containerized edge data center unit 500. IN some aspects, the rapid response containerized edge data center unit 500 can support smart glasses, extended reality (XR), mixed reality (MR), augmented reality (AR) headsets, displays, devices, etc., that can be used by the first responders on scene and populated with overlay information related to the rapid response event or response efforts, and transmitted from the rapid response edge unit 500 to the smart glasses or other XR, MR, AR, etc., device(s) worn by or otherwise associated with one or more first responders on scene of the rapid response event.

In some embodiments, the voice-to-text and/or text-to-voice and/or voice-to-voice interfaces provided by the rapid response edge unit 500 can be used to implement local conversational assistance (e.g., local conversational or generative Al models running locally at the edge, on the compute engine 530 of the rapid response containerized edge unit 500 and without communications back to the cloud or a remote server or other remote computing infrastructure). The local conversational assistance provided by the rapid response containerized edge data center unit 500 can be particularly important for giving operational assistance in rapid response events or other deployment scenarios where the emergency workers or first responders do not have easy access to a text keyboard or other user interface/input device, readable screen, etc., while actively working in the field to provide the rapid response event response or recovery efforts.

For example, many firefighters may have gloves and heavy gear on while responding to an event, during which the firefighters may also be seeking information on weather conditions, wind direction and speed, extents of forest fire, etc. The typical deployment gear worn or used by the firefighters (e.g., in this particular example, which is not intended to be construed as limiting) can make it very difficult for the firefighters to type into and/or otherwise interact with a text-based and display-based interface to request or query, and subsequently obtain and view, the relevant information As an additional limiting factor, the environment into which the firefighters may be deployed while actively providing the event response (e.g., an ongoing fire, etc.) is not conducive for looking into a small screen during operations. However, the firefighters may be equipped with headsets that include microphones, which can be configured to provide the voice-to-text, text-to-voice, voice-to-voice, etc., interfaces to the one or more local conversational/generative AI assistance models running locally on the edge compute engine 530 and/or associated with the emergency response engine 560 of the rapid response containerized edge data center unit 500.

By using the voice-based interfaces to the local AI conversational and/or generative assistance models running on the rapid response edge unit 500, the firefighters or other emergency responders can more easily, efficiently, and effectively talk and hear instructions, information, and advice during operations. As contemplated herein, the systems and techniques for providing the rapid response containerized edge data center unit (e.g., such as the rapid response containerized edge data center unit 500 of FIG. 5) can be configured to provide voice-enabled access to information in real time to support operations for the rapid response event. In some aspects, the rapid response containerized edge data center unit 500 can be configured to operate with and provide voice-enabled access and/or conversational information exchange to various devices worn by the first responders, devices which may include, but are not limited to, smart glasses, MR, AR, XR headsets, etc., for automated assistance and support (e.g., as noted previously above). In some embodiments, the smart glasses and MR, AR, XR, etc., headsets or other devices worn by first responders can include one or more cameras and/or sensors capable of relaying or streaming additional input information back to the rapid response edge unit 500.

For example, the cameras and/or sensors of the smart glasses or other MR/AR/XR devices or headsets worn by first responders can be included in or associated with one or more of the local sensors/devices 562, the remote sensors/devices 564, and/or the deployable units 566, etc., included in the rapid response containerized edge data center unit 500 of FIG. 5. Using headset camera footage obtained from the first responder smart glasses or MR/AR/XR devices, the rapid response edge unit 500 can implement one or more local edge ML/AI assistance agents, models, workloads, workflows, etc., that are configured to provide assistance to the first responders and rapid response event efforts using one or more communication modalities.

For example, local edge ML/AI assistance models running on the compute engine 530can be configured to provide visual overlays to the camera feeds of the first responders, as well as to provide visual information (e.g., in the form of images, videos, text, etc.) to be added to the first responders smart glasses/XR headset view in real-time during the rapid response event. The visual overlays and/or visual augmentation information provided to the first responders by the rapid response containerized edge data center unit 500 can be in addition to audio information transmitted and/or received to the headset and microphone of the first responders, as described above, which may be included in the same smart glasses/XR headset device worn by the first responders and/or may be included in separate voice-based bi-directional communication devices worn by the first responders and associated to the rapid response containerized edge data center unit 500.

In one illustrative example, the rapid response containerized edge data center unit 500 can be configured to run one or more local edge ML/AI assistance models configured to provide visual and/or 3D sensing-based analyses, including examples where the visual and/or 3D sensing analyses are used to provide or drive information outputs provided to one or more first responders in communication with the rapid response containerized edge data center unit 500. For example, the visual and 3D sensing analysis local edge ML/AI assistance models can be fed with inputs that are obtained from various sensors, cameras, image capture devices, etc., that may be included in the rapid response containerized edge data center unit 500 (e.g., the local sensors/devices 562, the remote sensors/devices 564, the deployable units 566, the peripheral devices 580, etc.). The visual and 3D sensing analysis local edge ML/AI assistance models can additionally be fed with inputs that are obtained remotely, for example transmitted to the rapid response containerized edge data center unit 500 over a remote communications link provided by the communications engine 520 and remote communications system(s) 526 thereof, etc.

In some aspects, the local edge ML/AI assistance models can provide visual and/or 3D sensing-based analysis of the input sensor data and image data, for instance implementing computer vision processing for inputs such as thermal and/or FLIR images, 3D stereo and range scans, hyperspectral images, X-ray images, and/or satellite imagery (among various others). In some cases, multiple different local edge ML/AI assistance models can be provided on the rapid response containerized edge data center unit 500 and each used to process a corresponding or specific subset of the sensor and image data inputs that may be received for the visual and/or 3D sensing-based analyses. In some examples, one or more local edge ML/AI assistance models can be configured to perform the visual and/or 3D sensing-based analysis using all of the available input data types.

In some embodiments, the visual and/or 3D sensing-based analysis can be implemented by the local edge ML/AI assistance models performing various data processing operations on the input sensor and image data. The data processing operations of the local edge ML/AI assistance models can include, but are not limited to, one or more (or all) of 3D modeling and/or structural modeling; detection, recognition and/or classification of objects, protective gear or PPE, safety procedures, scene parts or components, humans, vehicles, and/or activities, etc.; localization, navigation, and/or path planning; scene surveillance and/or monitoring; etc.

In some examples, the systems and techniques described herein can be implemented or otherwise performed by a computing device, apparatus, or system. In one example, the systems and techniques described herein can be implemented or performed by a computing device or system having the computing device architecture 800 of FIG. 8. The computing device, apparatus, or system can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a laptop computer, a smart television, a camera, and/or any other computing device with the resource capabilities to perform the processes described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Processes described herein can comprise a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 illustrates an example computing device architecture 800 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. The components of computing device architecture 800 are shown in electrical communication with each other using connection 805, such as a bus. The example computing device architecture 800 includes a processing unit (CPU or processor) 810 and computing device connection 805 that couples various computing device components including computing device memory 815, such as read only memory (ROM) 820 and random-access memory (RAM) 825, to processor 810.

Computing device architecture 800 can include a cache of high-speed memory connected directly with, in close proximity to, or integrated as part of processor 810. Computing device architecture 800 can copy data from memory 815 and/or the storage device 830 to cache 812 for quick access by processor 810. In this way, the cache can provide a performance boost that avoids processor 810 delays while waiting for data. These and other engines can control or be configured to control processor 810 to perform various actions. Other computing device memory 815 may be available for use as well. Memory 815 can include multiple different types of memory with different performance characteristics. Processor 810 can include any general-purpose processor and a hardware or software service, such as service 1 832, service 2 834, and service 3 836 stored in storage device 830, configured to control processor 810 as well as a special-purpose processor where software instructions are incorporated into the processor design. Processor 810 may be a self-contained system, containing multiple cores or processors, a bus, memory controller, cache, etc. A multi-core processor may be symmetric or asymmetric.

To enable user interaction with the computing device architecture 800, input device 845 can represent any number of input mechanisms, such as a microphone for speech, a touch-sensitive screen for gesture or graphical input, keyboard, mouse, motion input, speech and so forth. Output device 835 can also be one or more of a number of output mechanisms known to those of skill in the art, such as a display, projector, television, speaker device, etc. In some instances, multimodal computing devices can enable a user to provide multiple types of input to communicate with computing device architecture 800. Communication interface 840 can generally govern and manage the user input and computing device output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof. Storage device 830 can include services 832, 834, 836 for controlling processor 810. Other hardware or software modules or engines are contemplated. Storage device 830 can be connected to the computing device connection 805. In one aspect, a hardware module that performs a particular function can include the software component stored in a computer-readable medium in connection with the necessary hardware components, such as processor 810, connection 805, output device 835, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

The term “network entity” or “base station” may refer to a single physical Transmission-Reception Point (TRP) or to multiple physical Transmission-Reception Points (TRPs) that may or may not be co-located. For example, where the term “network entity” or “base station” refers to a single physical TRP, the physical TRP may be an antenna of a base station (e.g., satellite constellation ground station/internet gateway) corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Because a TRP is the point from which a base station transmits and receives wireless signals, as used herein, references to transmission from or reception at a base station are to be understood as referring to a particular TRP of the base station.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

What is claimed is:

1. A rapid response containerized edge data center apparatus for deployment to an edge location associated with an emergency or rapid response event, the apparatus comprising:
a container housing defining an enclosed interior volume, wherein the container housing comprises a shipping container having a configured length;
a power control module configured to generate and provide electrical power to the rapid response containerized edge data center apparatus, the power control module including one or more electrical generators and one or more battery arrays;
a low-latency edge compute engine comprising one or more server racks included within the enclosed interior volume of the container housing, wherein the low-latency edge compute engine utilizes computational hardware of the one or more server racks to implement local inference for one or more machine learning (ML) or artificial intelligence (AI) applications deployed to the rapid response containerized edge data center apparatus;
a local networking communications node configured to create one or more local networks at the edge location using one or more local network wireless communication modalities;
a plurality of satellite transceivers coupled to the container housing and configured for communications with one or more satellite internet constellations, wherein the apparatus includes a link bonding engine configured to create a bonded satellite uplink and a bonded satellite downlink using a plurality of individual satellite uplinks and downlinks associated with the plurality of satellite transceivers; and
a communications hub engine configured to provide communications relay between devices on the one or more local networks, and configured to connect the devices on the one or more local networks to one or more remote endpoints reachable over the bonded satellite uplink and bonded satellite downlink.

2. The apparatus of claim 1, wherein the communications hub engine is configured to generate and transmit emergency notification information to a plurality of connected devices on the one or more local networks at the edge location associated with the emergency or rapid response event.

3. The apparatus of claim 2, wherein the plurality of connected devices comprise user computing devices associated with an impacted population of the emergency or rapid response event, and user computing devices associated with emergency responders to the emergency or rapid response event.

4. The apparatus of claim 2, wherein the communications hub engine is configured to generate and transmit command and control information corresponding to an event response for the emergency or rapid response event.

5. The apparatus of claim 4, wherein the command and control information is transmitted to a subset of connected devices on the one or more local networks that are associated with emergency responders.

6. The apparatus of claim 1, wherein the one or more local networks include one or more of:
a private cellular network implemented using a cellular network core included within or configured by the rapid response containerized edge data center apparatus; or
a private mesh network implemented by the communications hub engine and the local networking communications node.

7. The apparatus of claim 1, wherein the bonded satellite uplink and the bonded satellite downlink are configured as an internet backhaul of the rapid response containerized edge data center apparatus.

8. The apparatus of claim 1, wherein:
a first subset of the plurality of satellite transceivers are configured for communications with a first satellite internet constellation, and a second subset of the plurality of satellite transceivers are configured for communications with a second satellite internet constellation different from the first satellite internet constellation.

9. The apparatus of claim 8, wherein the link bonding engine is configured to perform bonding across individual links to the first and second satellite internet constellations to thereby create the bonded satellite uplink and the bonded satellite downlink.

10. The apparatus of claim 1, wherein the one or more ML or AI applications comprise emergency and disaster response applications configured to perform local inference at the edge location using sensor data obtained from a combination of local sensors coupled to the container housing, remote sensors external to the container housing and connected via the one or more local networks, and deployable sensor devices deployed from the rapid response containerized edge data center apparatus.

11. The apparatus of claim 10, wherein the deployable sensor devices include one or more of drones, unmanned aerial vehicles (UAVs), uncrewed ground vehicles (UGVs), autonomous underwater vehicles (AUVs), unmanned surface vehicles (USVs), or embedded robotic units.

12. The apparatus of claim 1, wherein the low-latency edge compute engine is configured to implement one or more dashboard or visualization applications based on local edge analysis of real-time streams of the sensor data received at the local networking communications node using the one or more local networks at the edge location.

13. The apparatus of claim 1, wherein the one or more ML or AI applications include one or more generative AI models trained to provide local conversational assistance to emergency responders at the edge location associated with the emergency or rapid response event, wherein the local conversational assistance is based on one or more of voice-to-text or text-to-voice interfaces between the one or more generative AI models and respective communication devices of the emergency responders.

14. The apparatus of claim 11, wherein:
the respective communication devices of the emergency responders comprise smart glasses, extended reality (XR) headsets, mixed reality (MR) headsets, or augmented reality (AR) headsets; and
the one or more ML or AI applications further include one or more additional AI assistance models trained to provide local visual assistance based on generating and transmitting one or more visual information overlays for output on a display of the respective communication devices of the emergency responders.

15. The apparatus of claim 1, wherein:
the power control module is associated with a power source hub configuration that causes the rapid response containerized edge data center apparatus to power one or more externally connected electrical loads associated with the emergency or rapid response event; and
the one or more externally connected electrical loads are powered based on one or more of real-time electrical generation using the one or more electrical generators, or stored electrical energy from the one or more battery arrays.

16. The apparatus of claim 1, wherein the power control module further includes an energy supply interface configured to receive as input electrical grid power from electrical power infrastructure associated with the edge location, and wherein the power control module is configured to utilize the one or more electrical generators and the one or more battery arrays as backup to the input electrical grid power.

17. The apparatus of claim 1, wherein the one or more electrical generators include one or more of:
a combustion-powered generator external to the container housing and connected to the power control module; or
an integrated solar panel array coupled to and deployed from the container housing.

18. The apparatus of claim 1, wherein the one or more electrical generators include one or more external solar panel arrays external to the container housing and connected to the power control module.

19. The apparatus of claim 1, wherein the one or more ML or AI applications include one or more local edge ML or AI assistance models configured to perform computer vision (CV)-based processing of image data obtained from the edge location, and wherein the image data includes one or more of thermal images, three-dimensional (3D) stereo or range scans, hyperspectral images, X-ray images, or satellite images.

20. The apparatus of claim 19, wherein the one or more local edge ML or AI assistance models are configured to perform the CV-based processing of the image data to implement one or more of 3D structural modeling, detection or classification of objects or activities represented within the image data, navigation and path planning, or scene surveillance and monitoring.
